(19) United States
(12) Patent Application Publication
(10) Pub. No.: US 2008/0123876 A1
(43) Pub. Date: May 29, 2008

(54) ELECTROSTATIC PRESSURE TRANSDUCER AND MANUFACTURING METHOD THEREFOR

(75) Inventors: AKIYOSHI SATO, Hamamatsu-Shi (JP); Yukitoshi Suzuki, Hamamatsu-shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: YAMAHA CORPORATION, Hamamatsu-Shi (JP)

(21) Appl. No.: 11/872,105

(22) Filed: Oct. 15, 2007

(30) Foreign Application Priority Data
Oct. 16, 2006 (JP) 2006-281889
Mar. 27, 2007 (JP) 2007-081423

(51) Int. Cl. H04R 25/00

(52) U.S. Cl. 381/174

(57) ABSTRACT

An electrostatic pressure transducer (e.g., a condenser microphone) includes a plate having a plurality of holes and forming a fixed electrode, a diaphragm forming a vibrating electrode, at lease one spacer that is positioned between the plate and the diaphragm in the ring-shaped internal area internally of the peripheral end of the diaphragm, and a stopper plate having an opening, which is positioned opposite to the plate with respect to the diaphragm. The diaphragm vibrates relative to the plate in such a way that, due to electrostatic attraction, the internal portion thereof moves close to the plate while the external portion thereof moves opposite to the plate, wherein the peripheral end thereof partially comes in contact with the opening edge of the stopper plate. Thus, it is possible to realize flat frequency characteristics while improving the sensitivity in low-frequency ranges.

### BACKGROUND OF THE INVENTION

1. Field of the Invention

The present invention relates to electrostatic pressure transducers such as condenser microphones adapted to MEMS (Micro-Electro-Mechanical Systems). The present invention also relates to manufacturing methods of electrostatic pressure transducers.

This application claims priority on Japanese Patent Application No. 2006-281889 and Japanese Patent Application No. 2007-81423, the contents of which are incorporated herein by reference.

2. Description of the Related Art

It is conventionally known that electrostatic pressure transducers, in particular, condenser microphones, have been manufactured by way of MEMS (Micro-Electro-Mechanical System) manufacturing processes. Japanese Patent Application Publication No. 2004-506394 teaches a miniature broadband transducer serving as a condenser microphone. This condenser microphone includes a plate forming a fixed electrode and a diaphragm forming a vibrating electrode, which are positioned in proximity to a substrate (or a wiring portion joining a die). It is possible to adopt either a first structure, in which the diaphragm is positioned close to the wiring portion rather than the plate, or a second structure, in which the plate is positioned close to the wiring portion rather than the diaphragm. In each of the first and second structures, the diaphragm serves as a partition membrane for partitioning an acoustic space positioned opposite to the wiring portion and a non-acoustic space positioned close to the wiring portion. In addition, a plurality of holes are formed in the plate. In the first structure in which the diaphragm is positioned close to the wiring portion rather than the plate, a cavity is formed by the diaphragm in proximity to the wiring portion. In the second structure in which the plate is positioned close to the wiring portion rather than the diaphragm, a cavity is formed by the plate in proximity to the wiring portion. When a static pressure difference occurs between the acoustic space and the non-acoustic space, the condenser microphone is degraded in sensitivity. In order to avoid degradation of the sensitivity, it is necessary to form a passage establishing a balance between the air pressure of the non-acoustic space and the atmospheric pressure.

However, when sound waves enter into the non-acoustic space via the passage connecting between the acoustic space and the non-acoustic space, which are partitioned by use of the diaphragm, the condenser microphone is degraded in sensitivity. It is difficult to increase the acoustic resistance of the passage so as to cope with sound waves of low-frequency ranges, in other words, it is difficult to reduce the width (or the cross-sectional size) of the passage. For this reason, conventionally-known condenser microphones each have frequency characteristics in which the sensitivity thereof is degraded in low-frequency ranges.

In addition, silicon microphones (or silicon condenser microphones) have been known as examples of small-size electrostatic pressure transducers, which are produced by way of semiconductor manufacturing processes. In the miniature broadband transducer disclosed in Japanese Patent Application Publication No. 2004-506394, which serves as an electrostatic pressure transducer, a pair of electrodes oppositely positioned is realized by an electrode plate having a relatively high rigidity and a diaphragm having a relatively low rigidity, wherein the gap between the electrode plate and the diaphragm is reduced when the diaphragm is attracted to the electrode plate due to an electric field caused by a bias voltage, but the gap is maintained when the diaphragm comes in contact with projections of the electrode plate. This type of the electrostatic pressure transducer has the following problems.

The sensitivity of the silicon microphone is improved as the distance between the electrode plate and the diaphragm is reduced. However, there likely occurs a pull-in phenomenon in which the diaphragm subjected to pressure is deflected and is attracted to the electrode plate upon application of a bias voltage. This degrades the stability of the diaphragm against mechanical vibration thereof, and this reduces the rated pressure of the diaphragm. When the diaphragm is attracted to the electrode plate, the distance between the diaphragm and the substrate increases so as to reduce the acoustic resistance of the space communicating with the back cavity of the substrate, thus reducing the sensitivity in low-frequency ranges.

### SUMMARY OF THE INVENTION

It is an object of the present invention to provide an electrostatic pressure transducer such as a condenser microphone, in which the sensitivity regarding sound waves of low-frequency ranges is improved so as to realize flat sensitivity characteristics.

It is another object of the present invention to provide a manufacturing method of the electrostatic pressure transducer.

It is a further object of the present invention to realize a high-level balance between the stability and the sensitivity with respect to the electrostatic pressure transducer.

In a first aspect of the present invention, an electrostatic pressure transducer (e.g., a condenser microphone) includes a plate having a plurality of holes and forming a fixed electrode, a diaphragm forming a vibrating electrode, which is positioned opposite to the fixed electrode, at least one spacer that is positioned between the plate and the diaphragm in a ring-shaped area inwardly of the peripheral end of the diaphragm, and a stopper plate having an opening, which is positioned opposite to the plate with respect to the diaphragm, wherein the diaphragm vibrates relative to the plate in such a way that, due to electrostatic attraction occurring between the plate and the diaphragm, the internal portion of the diaphragm positioned inwardly of the spacer moves close to the plate while the external portion of the diaphragm positioned externally of the spacer moves opposite to the plate so that the peripheral end of the diaphragm partially comes in contact with the edge of the opening of the stopper plate.

It is preferable that the space allowing the diaphragm to vibrate be increased as large as possible, and it is preferable that the passage connecting between the acoustic space and the non-acoustic space partitioned by the diaphragm be reduced in width. In the condenser microphone, the passage connecting between the acoustic space and the non-acoustic space is formed using the space between the diaphragm and the stopper plate.

When the condenser microphone adopts the first structure in which the diaphragm is positioned between the plate and the substrate (formed using a silicon wafer), the substrate serves as the stopper plate. Upon application of a bias voltage, due to electrostatic attraction occurring between the plate and the diaphragm, the diaphragm is attracted to the plate so as to partially come in contact with the spacer, wherein the peripheral end of the diaphragm partially comes in contact with the opening edge of the stopper plate, thus allowing the diaphragm to vibrate even when the passage connecting between the acoustic space and the non-acoustic space is reduced in width. This increases the acoustic resistance of the passage connecting between the acoustic space and the non-acoustic space; and this makes it difficult for sound waves of low-frequency ranges to pass through the passage. That is, it is possible to prevent the sensitivity of the condenser microphone from being degraded due to sound waves unexpectedly entering into the non-acoustic space defined by the diaphragm. The condenser microphone can be modified such that the overall periphery of the diaphragm comes in contact with the opening edge of the substrate serving as the stopper plate. In this modification, it is preferable that a small gap be formed at an appropriate position in order to establish a balance between the air pressure of the non-acoustic space and the atmospheric pressure.

Of course, the condenser microphone can be redesigned to adopt the second structure in which the plate is positioned between the diaphragm and the substrate (formed using the silicon wafer). In this structure, the stopper plate is positioned further from the wiring portion rather than the diaphragm. The wiring portion is a multilayered wiring substrate forming the bottom of a package encapsulating the electrostatic pressure transducer, or it corresponds to the bottom of a package embedding a lead frame. When the die of the condenser microphone directly joins a circuit board for mounting other electronic components, the wiring portion corresponds to the circuit board. Due to electrostatic attraction occurring between the plate and the diaphragm upon application of the bias voltage, the diaphragm is attracted to the plate so as to partially come in contact with the spacer, wherein the peripheral end of the diaphragm partially comes in contact with the opening edge of the stopper plate, thus allowing the diaphragm to vibrate even when the passage connecting between the acoustic space and the non-acoustic space is reduced in width. This increases the acoustic resistance of the passage connecting between the acoustic space and the non-acoustic space; and this makes it difficult for sound waves of low-frequency ranges to pass through the passage. Thus, it is possible to prevent the sensitivity of the condenser microphone from being degraded due to sound waves unexpectedly entering into the non-acoustic space defined by the diaphragm.

That is, it is possible for the condenser microphone to have flat frequency characteristics without degradation of the sensitivity in low-frequency ranges.

Without application of the bias voltage, the non-acoustic space is not closed in an airtight manner; hence, it is possible to establish a balance between the air pressure of the non-acoustic space and the atmospheric pressure in the condenser microphone. This reliably prevents the diaphragm from being unexpectedly destroyed due to the air pressure difference occurring between the acoustic space and the non-acoustic space; hence, it is possible to prevent the sensitivity of the condenser microphone from being degraded due to the air pressure difference.

Alternatively, an electrostatic pressure transducer (e.g., a condenser microphone) includes a plate having a plurality of holes and forming a fixed electrode, a diaphragm forming a vibrating electrode, which is positioned opposite to the fixed electrode, at least one spacer that is positioned between the plate and the diaphragm and that has a ring-shaped interior wall positioned externally of the outermost hole within the holes of the plate, and a wall that supports the peripheral end of the plate so as to surround a non-acoustic space, which is defined by the diaphragm in proximity to a wiring portion, together with the diaphragm, the plate, and the wiring portion, wherein the diaphragm vibrates relative to the plate in such a way that, due to electrostatic attraction occurring between the plate and the diaphragm, the diaphragm moves close to the plate so as to close an opening surrounded by the spacer and to substantially close the non-acoustic space in an airtight manner.

In the above, upon application of a bias voltage, the diaphragm is attracted to the plate due to electrostatic attraction occurring between the plate and the diaphragm, thus closing the non-acoustic space in an airtight manner. This prevents sound waves from unexpectedly entering into the non-acoustic space; hence, it is possible to prevent the sensitivity of the condenser microphone from being degraded. In other words, it is possible for the condenser microphone to realize flat frequency characteristics without degradation of the sensitivity in low-frequency ranges. The interior wall of the spacer is substantially formed in a ring shape, wherein it is preferable that a small gap be formed in the ring-shaped interior wall of the space in order to decrease the cutoff frequency to be lower than the audio frequency range. In short, the interior wall of the spacer can be formed in either a perfect ring shape or an imperfect ring shape including a small gap allowing the cutoff frequency to be lower than the audio frequency range or to be close to the lower-limit frequency of the audio frequency range. When the interior wall of the spacer is formed in the perfect ring shape, it is preferable that an additional gap be formed at a prescribed position other than the spacer so as to establish a balance between the air pressure of the acoustic space and the atmospheric pressure.

The wiring portion is a multilayered wiring substrate forming the bottom of a package encapsulating the condenser microphone, or it corresponds to the bottom of a package embedding a lead frame. When the die of the condenser microphone directly joins a circuit board for mounting electronic components, the wiring portion corresponds to the circuit board.

Without application of the bias voltage, the non-acoustic space is not closed in an airtight manner; hence, it is possible to establish a balance between the air pressure of the acoustic space and the atmospheric pressure. This prevents the diaphragm from being unexpectedly destroyed due to the air pressure difference; thus, it is possible to prevent the sensitivity of the condenser microphone from being degraded due to the air pressure difference.

Incidentally, each of the aforementioned electrostatic pressure transducers can further include a plurality of springs interconnected to the diaphragm, and a support, which is interconnected to the springs so that the diaphragm is bridged across the support. In general, thin films inevitably have internal stresses during formation processes thereof. In the condenser microphone, the diaphragm (which is a thin film) is bridged across the support via the springs; hence, the stress of the diaphragm is released by the springs, while the tension of the diaphragm (which is reaction of the stress of the diaphragm) is also released by the springs. For this reason, it is possible to increase the amplitude of the diaphragm, and it is possible to improve the sensitivity of the condenser microphone.

In a manufacturing method adapted to the electrostatic pressure transducer according to the first aspect of the present invention, a first film serving as the diaphragm is formed; a first insulating film is formed on the first film; a second film serving as the plate is formed on the first insulating film; at least one hole is formed in the first insulating film by way of resist patterning and etching; a second insulating film whose composition differs from the composition of the first insulating film is deposited inside of the hole so as to form a spacer composed of the second insulating film; then, the first insulating film is selectively removed from the prescribed area between the first film and the second film by way of wet etching. This manufacturing method is advantageous in that the shape of the spacer having insulating property can be determined irrespective of the shape of the remaining portion of the first insulating film.

In a manufacturing method adapted to the electrostatic pressure transducer according to the second aspect of the present invention, a first film serving as the diaphragm is formed; a first insulating film is formed on the first film; a channel substantially having a ring shape is formed in the first insulating film by way of resist patterning and etching; a second insulating film whose composition differs from the composition of the first insulating film is deposited inside of the channel so as to form the spacer composed of the second insulating film; the internal portion of the second insulating film positioned internally of the spacer is removed; the second insulating film is removed so as to expose the first insulating film, on which the second film is formed; then, the first insulating film is removed from the prescribed area between the first film and the second film by way of wet etching. This manufacturing method is advantageous in that a ring-shaped spacer having an insulating property can be formed irrespective of the shape of the remaining portion of the first insulating film.

In a second aspect of the present invention, an electrostatic pressure transducer includes a stopper plate (or a substrate), a plate that is formed using a plate electrode film deposited on the stopper plate, a diaphragm that is formed using a diaphragm electrode film, and a plurality of cantilevers, each of which is deflected at a distal end thereof toward the diaphragm, which is thus depressed. Due to the internal stresses of the cantilevers, it is possible to increase a first gap between the plate and the diaphragm, thus improving the stability of the electrostatic pressure transducer.

In the above, the stopper plate forms a back cavity; the plate electrode film has a first through-hole; a second gap having an acoustic resistance, which is exerted between the back cavity and the first through-hole, is formed between the peripheral end of the diaphragm and the opening edge of the stopper plate; at least one second through-hole communicating with the first through-hole and the second gap is formed in the external portion of the diaphragm externally of the back cavity; and the first gap communicates with the first through-hole. Herein, an air pressure causing the displacement of the diaphragm is transmitted to the diaphragm via the first through-hole. When a non-acoustic space, which is defined by the diaphragm oppositely to the plate, has a relatively small volume and is closed in an airtight manner, the pressure applied to the non-acoustic space causes a reaction so as to reduce the displacement of the diaphragm, thus degrading the sensitivity. In addition, there is a possibility in that the diaphragm may be unexpectedly destroyed due to the air pressure difference between the air pressure of the non-acoustic space and the atmospheric pressure. Such a possibility can be eliminated because the second gap having the acoustic resistance, which is exerted between the diaphragm and the stopper plate, can be reduced to be smaller than the thickness of a sacrifice film that is deposited between the diaphragm electrode film and the stopper plate. Thus, it is possible to improve the sensitivity in low-frequency ranges while securing the high-level stability with respect to the electrostatic pressure transducer (e.g., the condenser microphone).

The diaphragm has a plurality of projections whose distal ends come in contact with the stopper plate so as to form the second gap. Since the second gap depends upon the height of the projection of the diaphragm, it is possible to precisely set up the sensitivity and to reliably secure the stability. Alternatively, the stopper plate has a plurality of projections that come in contact with the diaphragm so as to form the second gap. Since the second gap depends upon the height of the projection of the stopper plate, it is possible to precisely set up the sensitivity and to reliably secure the stability. Furthermore, a plurality of channels, which are elongated externally from the back cavity, are formed in the stopper plate so as to form the second gap, wherein the second gap depends upon the dimensions of the channels.

It is possible to form a plurality of second through-holes, wherein the diaphragm electrode film has a bent band-like shape between the adjacent second through-holes. This may easily cause the displacement of the diaphragm; hence, it is possible to reduce the internal stress of the cantilever, which is necessary to improve the sensitivity by increasing the first gap between the diaphragm and the plate during manufacturing.

The cantilever can be formed using a plurality of films, whereby it is easy to vary the internal stress of the cantilever in its thickness direction. Both of the cantilever and the plate electrode film can be formed using the common film in order to reduce the manufacturing cost.

The cantilevers have projections which project from the distal ends thereof toward the diaphragm and whose distal ends come in contact with the diaphragm, whereby it is possible to reduce the internal stresses of the cantilevers. Alternatively, a plurality of projections are formed in the diaphragm, wherein they project toward the cantilevers and come in contact with the distal ends of the cantilevers.

### BRIEF DESCRIPTION OF THE DRAWINGS

These and other objects, aspects, and embodiments of the present invention will be described in more detail with reference to the following drawings, in which:

FIG. 1A is a longitudinal sectional view taken along line A-A in FIG. 1C, which shows the constitution of a condenser microphone in accordance with a first embodiment of the present invention;

FIG. 1B is a longitudinal sectional view taken along line B-B in FIG. 1C;

FIG. 1C is a lateral sectional view taken along line C-C in FIGS. 1A and 1B;

FIG. 2 is a longitudinal sectional view diagrammatically showing that a diaphragm vibrates relative to a plate and in contact with spacers;

FIG. 3 is a partial sectional view showing an example of a laminated structure of films forming the condenser microphone shown in FIGS. 1A to 1C;

FIG. 4A is a sectional view for explaining a first step of a manufacturing method of the condenser microphone;

FIG. 4B is a sectional view for explaining a second step of the manufacturing method of the condenser microphone;

FIG. 4C is a sectional view for explaining a third step of the manufacturing method of the condenser microphone;

FIG. 4D is a sectional view for explaining a fourth step of the manufacturing method of the condenser microphone;

FIG. 5A is a sectional view for explaining a fifth step of the manufacturing method of the condenser microphone;

FIG. 5B is a sectional view for explaining a sixth step of the manufacturing method of the condenser microphone;

FIG. 5C is a sectional view for explaining a seventh step of the manufacturing method of the condenser microphone;

FIG. 6A is a sectional view for explaining an eighth step of the manufacturing method of the condenser microphone;

FIG. 6B is a sectional view for explaining a ninth step of the manufacturing method of the condenser microphone;

FIG. 7A is a sectional view for explaining a tenth step of the manufacturing method of the condenser microphone;

FIG. 7B is a sectional view for explaining an eleventh step of the manufacturing method of the condenser microphone;

FIG. 8A is a longitudinal sectional view taken along line A-A in FIG. 8C, which shows the constitution of a condenser microphone in accordance with a variation of the first embodiment of the present invention;

FIG. 8B is a longitudinal sectional view taken along line B-B in FIG. 8C;

FIG. 8C is a lateral sectional view taken along line C-C in FIGS. 8A and 8B;

FIG. 9 is a partial sectional view showing an example of a laminated structure of films forming the condenser microphone shown in FIGS. 8A to 8C;

FIG. 10A is a sectional view for explaining a first step of a manufacturing method of the condenser microphone;

FIG. 10B is a sectional view for explaining a second step of the manufacturing method of the condenser microphone;

FIG. 10C is a sectional view for explaining a third step of the manufacturing method of the condenser microphone;

FIG. 10D is a sectional view for explaining a fourth step of the manufacturing method of the condenser microphone;

FIG. 11A is a sectional view for explaining a fifth step of the manufacturing method of the condenser microphone;

FIG. 11B is a sectional view for explaining a sixth step of the manufacturing method of the condenser microphone;

FIG. 11C is a sectional view for explaining a seventh step of the manufacturing method of the condenser microphone;

FIG. 11D is a sectional view for explaining an eighth step of the manufacturing;

FIG. 12A is a sectional view for explaining a ninth step of the manufacturing method of the condenser microphone;

FIG. 12B is a sectional view for explaining a tenth step of the manufacturing method of the condenser microphone;

FIG. 13A is a sectional view taken along line 1A-1A in FIG. 13C, which shows the constitution of a condenser microphone in accordance with a second embodiment of the present invention;

FIG. 13B is a sectional view taken along line 1B-B1 in FIG. 13C;

FIG. 13C is a plan view of a plate included in the condenser microphone shown in FIGS. 13A and 13B;

FIG. 14A is a longitudinal sectional view diagrammatically showing an intermediate structure of the condenser microphone;

FIG. 14B is a plan view showing the pattern of a diaphragm electrode film forming a diaphragm of the condenser microphone;

FIG. 15A is a sectional view showing the constitution of a condenser microphone according to a variation of the second embodiment;

FIG. 15B is a sectional view showing the constitution of the condenser microphone shown in FIG. 15A;

FIG. 15C is a sectional view showing a laminated structure of films realizing the formation of channels shown in FIG. 15B;

FIG. 16 is a plan view of a diaphragm included in the condenser microphone shown in FIGS. 15A and 15B;

FIG. 17 is a plan view showing the pattern of a diaphragm electrode film included in the condenser microphone shown in FIGS. 15A and 15B;

FIG. 18A is a sectional view showing the constitution of a condenser microphone according to another variation of the second embodiment;

FIG. 18B is a sectional view showing the constitution of the condenser microphone shown in FIG. 18B;

FIG. 18C is a sectional view showing a laminated structure of films realizing the formation of channels shown in FIG. 18B;

FIG. 19 is a plan view showing the pattern of a diaphragm electrode film included in the condenser microphone shown in FIGS. 18A and 18B;

FIG. 20A is a sectional view showing the constitution of a condenser microphone according to a further variation of the second embodiment; and

FIG. 20B is a sectional view showing the constitution of a condenser microphone according to a still further variation of the second embodiment.

### DESCRIPTION OF THE PREFERRED EMBODIMENTS

The present invention will be described in further detail by way of examples with reference to the accompanying drawings.

### 1. First Embodiment

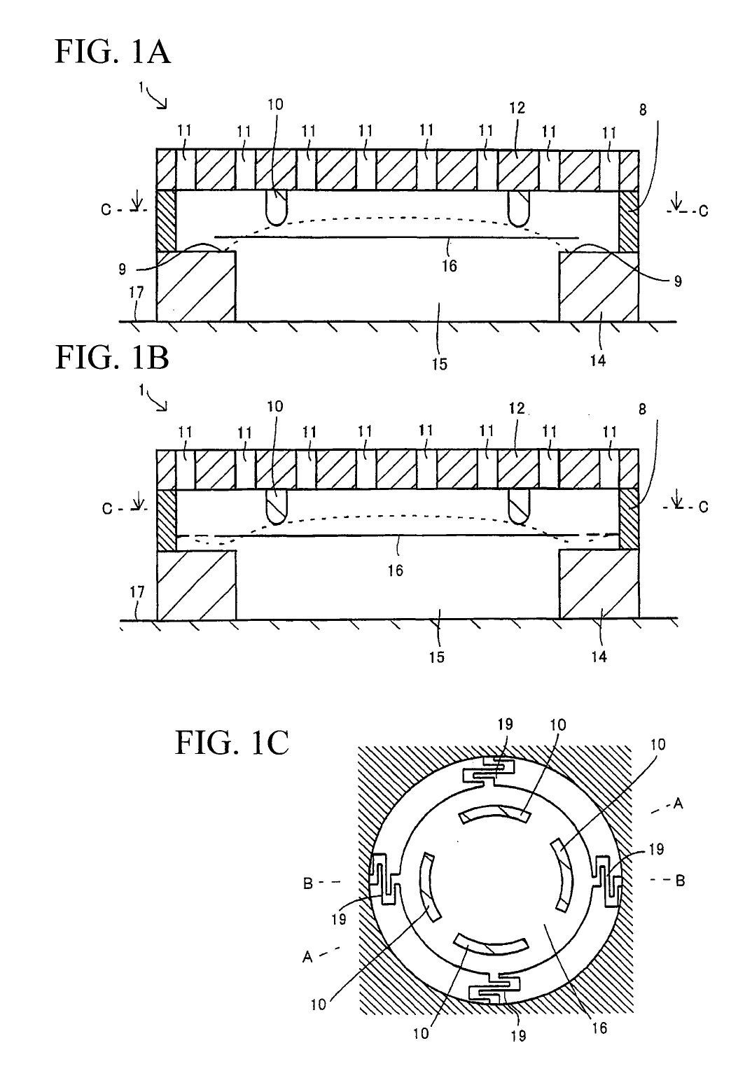

FIGS. 1A, 1B, and 1C are sectional views diagrammatically showing the constitution of a condenser microphone 1, without specific illustrations regarding laminated structures of films, in accordance with a first embodiment of the present invention. The cutting planes of FIGS. 1A and 1B are perpendicular to the surface of a plate 12. The cutting plane of FIG. 1C is parallel with the surface of the plate 12. FIG. 1C shows a diaphragm 16 viewed from the plate 12. Specifically, FIG. 1A is a longitudinal sectional view taken along line A-A in FIG. 1C, and FIG. 1B is a longitudinal sectional view taken along line B-B in FIG. 1C.

The condenser microphone 1 includes the plate 12 forming a fixed electrode and the diaphragm 16 forming a vibrating electrode. The plate 12 is fixed to a ring-shaped wall 8. The diaphragm 16 is bridged across the internal space defined by the wall 8 via springs 19.

A substrate 14 serving as a stopper plate is fixed to a wiring portion 17 via the adhesive. A through-hole (or an opening) is formed to run through the substrate 14 in its thickness direction so as to form a cavity 15 inwardly of an opening edge 9 of the substrate 14. The cavity 15 increases the volume of a non-acoustic space that is positioned opposite to the plate 12 with respect to the diaphragm 16. That is, the cavity 15 is formed to reduce the amplitude of a pressure vibration occurring in the non-acoustic space due to a vibration of the diaphragm 16.

The wall 8 is formed using one or more films formed on the substrate 14. The wall 8 connects between the plate 12 and the substrate 14. In the first embodiment, a support is defined as the interconnection portion of the wall 8 interconnected with the spring 19.

The diaphragm 16 is bridged across and above the cavity 15 via the springs 19 so as to partition an acoustic space and the non-acoustic space. The diaphragm 16 is formed using one or more films including a conductive film forming the vibrating electrode. Specifically, the diaphragm 16 has a circular outline covering the opening of the substrate 14, wherein the thickness of the diaphragm 16 ranges from 0.5 μm to 1.5 μm, for example.

The springs 19 are elongated from prescribed positions of the circumferential periphery of the diaphragm 16 towards the wall 8. An internal stress of the diaphragm 16 is reduced by way of the deformation of the springs 19.

The plate 12 is formed using one or more films including a conductive film forming the fixed electrode. A plurality of holes (i.e., sound holes 11) are formed to run through the plate 12 at prescribed positions. Sound waves are transmitted through the sound holes 11 so as to propagate inwardly into the condenser microphone 1, thus making the diaphragm 16 vibrate.

A plurality of spacers 10 are arranged between the plate 12 and the diaphragm 16 within a ring-shaped area viewed in a direction perpendicular to the diaphragm 16. The spacers 10 can be formed as islands that are dispersed in a direction perpendicular to the diaphragm 16. Alternatively, they can be formed in a ring shape. The base portions of the spacers 10 are interconnected to the plate 12. The height of the spacer 10 is smaller than the distance between the plate 12 and the diaphragm 16. Therefore, in the condition in which no external force is exerted on the diaphragm 16, the distal ends of the spacers 10 are distanced from the diaphragm 16. The number and the arrangement of the spacers 10 are appropriately designed on the basis of the shape, thickness, internal stress, and support structure of the diaphragm 16 as well as the characteristics of the condenser microphone 1.

In order to prevent the diaphragm 16 from being unexpectedly attracted to the plate due to electrostatic attraction occurring in the condenser microphone 1 having the aforementioned constitution, it is necessary to adjust the shapes of the springs 19, the internal stress of the diaphragm 16, the diameter of the ring-shaped area for arranging the spacers 10, and the height of the spacer 10. In order to realize the situation, in which, without exertion of electrostatic attraction, the distance between the peripheral end of the diaphragm 16 and the opening edge 9 of the substrate 14 becomes smaller than the distance between the diaphragm 16 and the opening edge 9 of the substrate 14, and the peripheral end of the diaphragm 16 may partially come in contact with the opening edge 9 of the substrate 14, it is necessary to adjust the internal area defined inwardly of the contact positions between the diaphragm 16 and the spacers 10, the width of the peripheral portion of the diaphragm 16 defined externally of the contact positions between the diaphragm 16 and the spacers 10, and the internal stress of the diaphragm 16. The internal stress of the diaphragm 16 is reduced by adjusting the film material forming the diaphragm 16, the thickness of the diaphragm 16, and the bias voltage applied to the diaphragm 16. The bias voltage ranges from 5 V to 15 V, for example.

The first embodiment is designed with prescribed dimensions in which, without application of the bias voltage, the distance between the plate 12 and the diaphragm 16 is set to 4 μm; the distance between the diaphragm 16 and the opening edge 9 of the substrate 14 is set to 1.5 μm; the distance between the peripheral end of the diaphragm 16 and the contact position between the diaphragm 16 and the spacer 10 is set to 130 μm; and the diameter of the internal area of the diaphragm 16 including the contact positions with the spacers 10 is set to 700 μm. In addition, the diaphragm 16 has an elastic deformability in that the center portion thereof approaches the plate 12 by 2 μm upon application of the bias voltage.

The condenser microphone 1 can be modified such that the circumferential periphery of the diaphragm 16 is entirely brought into contact with the opening edge 9 of the substrate 14. In this modification, it is preferable that a small gap be formed at an appropriate position (relative to the opening edge 9 or the spacer 10, for example) in order to establish a balance between the internal pressure of the non-acoustic space and the atmospheric pressure.

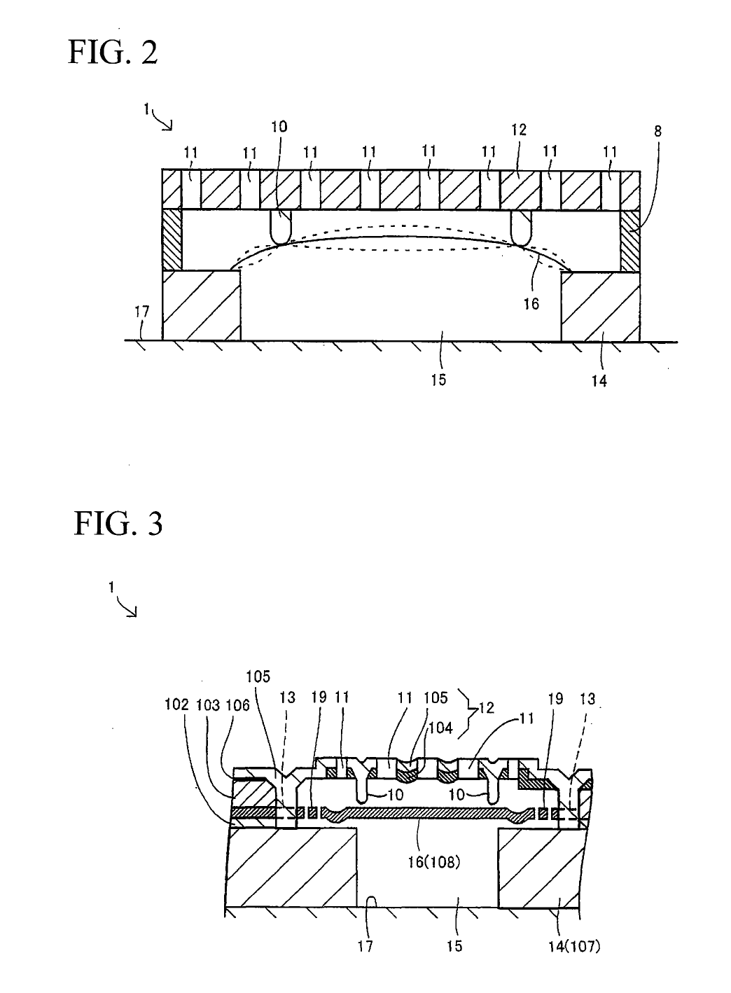

Next, the operation of the condenser microphone 1 will be described in detail. When a bias voltage boosted by a charge pump (not shown) is applied between the plate 12 and the diaphragm 16, the diaphragm 16 is partially brought into contact with the spacers 10 due to electrostatic attraction as shown by dotted lines in FIGS. 1A and 1B. That is, the internal area of the diaphragm 16 defined inwardly of the contact positions with the spacers 10 is attracted to the pate 12, while the peripheral portion of the diaphragm 16 defined externally of the contact positions with the spacers 10 approaches the substrate 14, so that the peripheral end of the diaphragm 16 except for the interconnection portions with the springs 19 is brought into contact with the inner end 9 of the substrate 14. In this state, when sound waves enter into the sound holes 11 so as to reach the diaphragm 16, the diaphragm 16 vibrates relative to the plate 12 because, compared with the diaphragm 16, the plate 12 has a large thickness and a high rigidity against deflection. At this time, the diaphragm 16 vibrates in contact with the spacers 10 as shown by dotted lines in FIG. 2.

As described above, the condenser microphone 1 of the first embodiment is capable of vibrating the diaphragm 16 while at least a prescribed part of the peripheral end of the diaphragm is brought into contact with the opening edge 9 of the substrate 14 serving as a stopper plate so as to reduce the width of the passage between the acoustic space and the non-acoustic space. This increases the acoustic resistance of the passage between the acoustic space and the non-acoustic space; and this makes it difficult for sound waves of low-frequency ranges to pass through the passage. That is, it is possible to control the degradation of the sensitivity of the condenser microphone 1, which occurs when sound waves unexpectedly enter into the non-acoustic space defined by the diaphragm 16. Compared with conventionally-known condenser microphones whose sensitivities are degraded with respect to sound waves of low-frequency ranges, the condenser microphone 1 of the first embodiment can realize flat frequency characteristics with respect to both sound waves of high-frequency ranges and sound waves of low-frequency ranges.

The non-acoustic space is not tightly closed when no bias voltage is applied to the diaphragm 16 of the condenser microphone 1, thus establishing a balance between the air pressure of the non-acoustic space and the atmospheric pressure. Even when a bias voltage is applied to the diaphragm 16, the non-acoustic space is not tightly closed, thus establishing a balance between the air pressure of the non-acoustic space and the atmospheric pressure. This makes it possible to prevent the diaphragm 16 from being destroyed due to air pressure difference; and this makes it possible to control the degradation of the sensitivity of the condenser microphone 1.

FIG. 3 is a partial sectional view showing an example of a laminated structure of films forming the condenser microphone 1.

The substrate 14 is formed using a wafer 107 composed of monocrystal silicon.

The wall 8, which surrounds the non-acoustic space defined by the diaphragm 16 in proximity to the wiring portion 17, is formed using an insulating film 105 forming the spacers 10 and an etching stopper film 102 as well as the substrate 14.

The plate 12 is formed using a conductive film 104 and the insulating film 105. The conductive film 104 forms the fixed electrode. The plate 12 is formed using the insulating film 105, in which the wall 8 is continuously interconnected to the surface layer of the plate 12; hence, the plate 12 is interconnected to the wall 8.

The spacer 10 is formed using the insulating film 105. Projections of the insulating film 105, which form the surface layer of the plate 12, which project toward the substrate 14, and which run through the plate 12, form the spacers 10; hence, the spacers 10 are interconnected to the plate 12.

The diaphragm 16, the springs 19, and the support 13 are formed using a conductive film 108 forming the vibrating electrode. The support 13 for supporting the springs 19 being connected with the diaphragm 16 is embedded in the wall 8 relative to the conductive film 108.

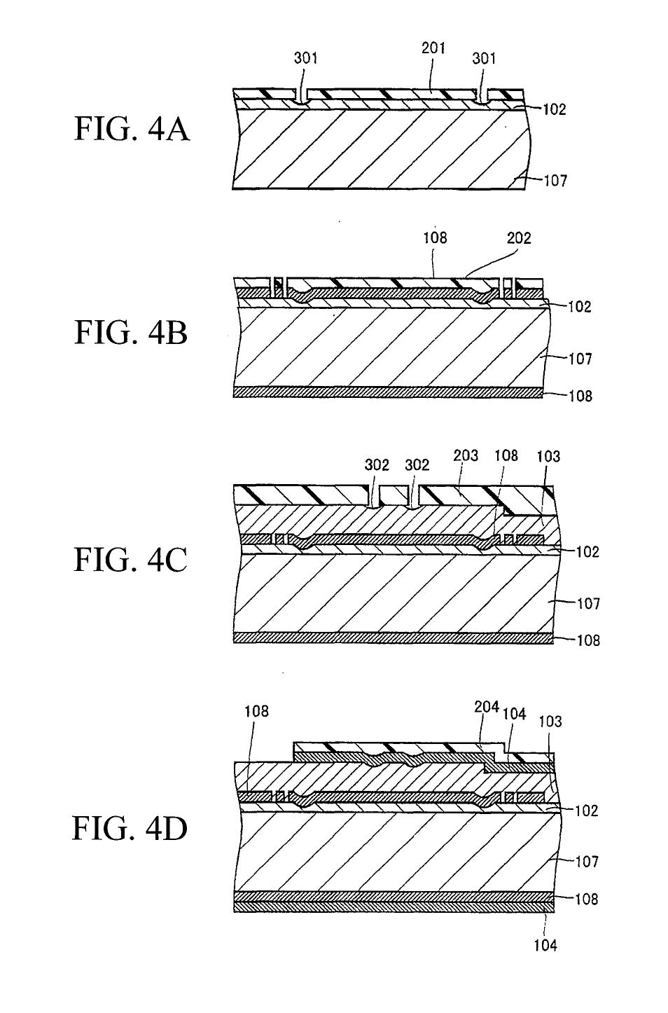

Next, a manufacturing method of the condenser microphone 1 will be described with reference to FIGS. 4A to 4D, FIGS. 5A to 5C, FIGS. 6A and 6B, and FIGS. 7A and 7B, which are sectional views used for the explanation of steps for manufacturing the condenser microphone 1. Each of these figures simply shows a sectional view with regard to a one-chip region, wherein pads, which are used for connecting the fixed electrode and vibrating electrode with a signal processing circuit (not shown), can be appropriately designed and are thus not shown.

In a first step shown in FIG. 4A, the etching stopper film 102 is formed on the wafer 107 composed of monocrystal silicon. The etching stopper film 102 is a sacrifice film having insulating ability composed of SiO₂ for use as an endpoint control in Deep-RIE (where RIE stands for Reactive Ion Etching), which will be described later. Next, a pattern of a resist mask 201 is transferred onto the etching stopper film 102 by way of wet etching, thus forming dimples 301 in the etching stopper film 102.

In a second step shown in FIG. 4B, the conductive film 108 is formed on the etching stopper film 102, then, a pattern of a resist mask 202 is transferred to the conductive film 108, thus forming the outline of the diaphragm 16 and the outlines of the springs 19. The diaphragm 16 and the springs 19 are formed using the conductive film 108. The conductive film 108 is composed of a metal film or a polycrystal silicon film, which is deposited by way of decompression CVD (where CVD stands for Chemical Vapor Deposition), which is doped with impurities such as phosphorus (P), and which is subjected to annealing.

In a third step shown in FIG. 4C, a spacer film 103 is formed above the etching stopper film 102 and the conductive film 108, then, a pattern of a resist mask 203 is transferred to the spacer film 103, thus forming dimples 302 in the spacer film 103. The spacer film 103 is formed in a desired thickness in such a way that SiO₂ is thinly deposited by way of CVD and is repeatedly subjected to annealing, for example.

In a fourth step shown in FIG. 4D, the conductive film 104 is formed on the spacer film 103, then, a pattern of a resist mask 204 is transferred to the conductive film 104, thus forming the outline of the fixed electrode (which is formed using the conductive film 104). The conductive film 104 is composed of a metal film or a polycrystal silicon film, which is deposited by way of decompression CVD, which is doped with impurities such as phosphorus, and which is subjected to annealing.

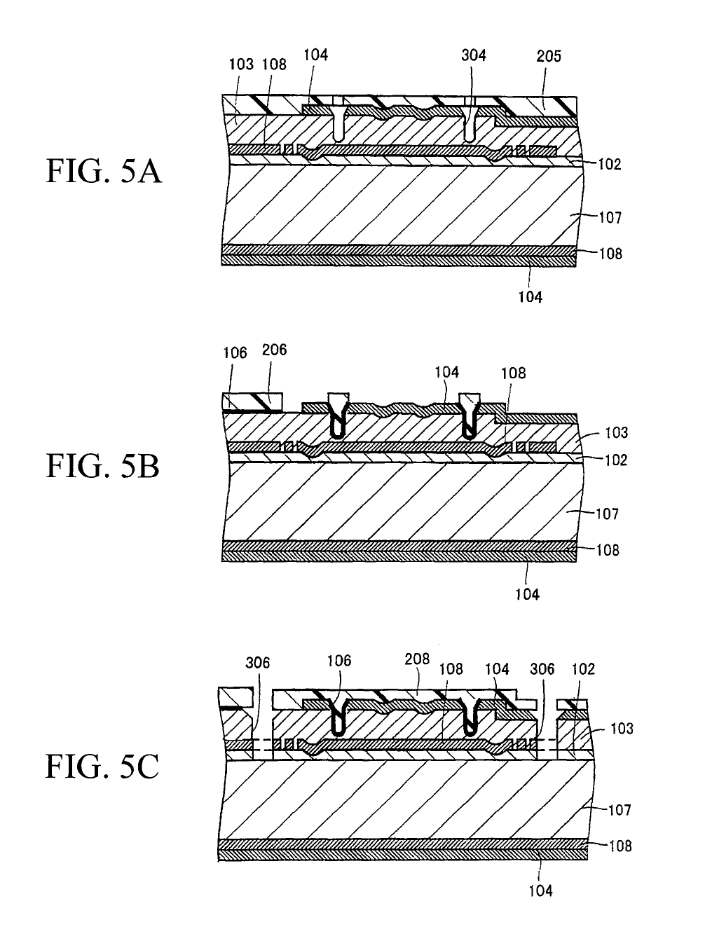

In a fifth step shown in FIG. 5A, by way of etching realizing the transfer of a pattern of a resist mask 205, holes 304 used for the formation of the spacers 10 are formed in the conductive film 104 and the spacer film 103. Specifically, the conductive film 104 is subjected to isotropic etching, then, the spacer film 103 is subjected to anisotropic dry etching. The anisotropic dry etching is stopped before the etched portions reach the conductive film 108, whereby it is possible to form the holes 304 used for the formation of the spaces 10 having thin distal ends. Even when the depths of the holes 304 are set so as to make the conductive film 108 be exposed, it is possible to isolate the spacers 10 from the diaphragm 16 by removing an insulating film 106 (which is formed in the next step).

Incidentally, the holes 304 are not necessarily formed by way of the aforementioned resist patterning and etching; therefore, it is possible to form the holes 304 by way of nano-imprint technology, for example.

In a sixth step shown in FIG. 5B, the insulating film 106 is formed on the spacer film 103, then, a pattern of a resist mask 206 is transferred to the insulating film 106, thus removing the unnecessary portion of the insulating film 106. The insulating film 106 is composed of SiO₂, which is subjected to CVD, for example. The insulating film 106 provides insulation between the conductive film 108 forming the diaphragm 16 and the conductive film 104 forming the plate 12.

In a seventh step shown in FIG. 5C, the spacer film 103 and the etching stopper film 102 are partially removed by use of a resist mask 208, thus forming holes 306, which are used for the formation of a prescribed portion of the insulating film 105 serving as the wall 8. Specifically, the spacer film 103 is subjected to isotropic wet etching, then, the spacer film 103 and the etching stopper film 102 are subjected to anisotropic dry etching, thus forming the holes 306 for exposing the wafer 107. A prescribed portion of the etching stopper film 102 covered with the conductive film 108 is not removed because the conductive film 108 defines an endpoint of etching.

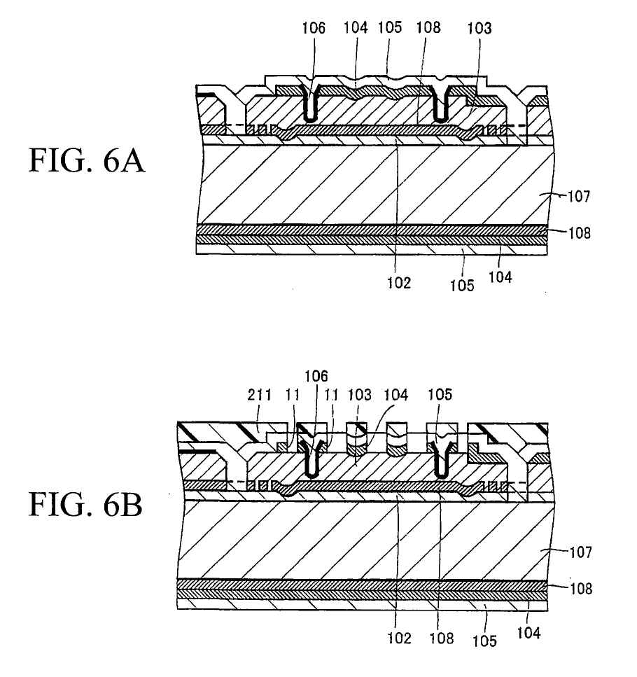

In an eighth step shown in FIG. 6A, an insulating film 105 is formed above the spacer film 103 and the conductive film 104. The insulating film 105 is composed of a prescribed material having etching selectiveness with the spacer film 103. For example, the insulating film 105 is formed using a SiN film whose thickness is adjusted by repeatedly performing decompression CVD and annealing.

In a ninth step shown in FIG. 6B, a pattern of a resist mask 211 is transferred to the insulating film 105 by way of etching, thus forming the sound holes 11 running through the insulating film 105 and the conductive film 104. Specifically, anisotropic etching is performed twice using different etching gases so as to form the sound holes 11.

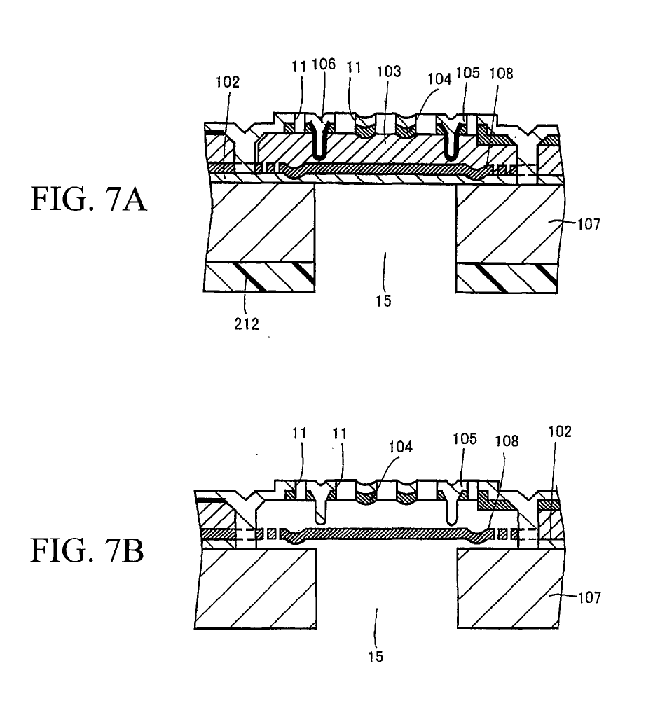

Next, the conductive film 108, the conductive film 104, and the insulating film 105, which are sequentially deposited on the backside of the wafer 107, are removed by way of back-grinding; thereafter, in a tenth step shown in FIG. 7A, a resist mask 212 is formed on the backside of the wafer 107, which is then subjected to Deep-RIE so as to form the cavity 15.

In an eleventh step shown in FIG. 7B, the insulating film 105 is used as an etching stopper so as to supply an etchant into the sound holes 11 and the cavity 15, thus removing unwanted portions of the etching stopper film 102 and the spacer film 103 by way of wet etching.

Lastly, the wafer 107 is divided into individual pieces by way of dicing. Thus, it is possible to complete the production of the condenser microphone 1 shown in FIG. 3.

The first embodiment is designed to be adapted to the foregoing first structure, in which the diaphragm is positioned closer to the wiring portion rather than the plate. Of course, it is possible to modify the first embodiment to be adapted to the foregoing second structure, in which the plate is positioned closer to the wiring portion rather than the diaphragm. In this modification, the stopper plate having an opening allowing sound waves to enter therein is positioned opposite to the wiring portion with respect to the diaphragm. That is, the substrate having the opening is adhered onto the wiring portion, wherein the plate and the stopper plate are supported by the wall interconnected to the substrate. In addition, the spacers are formed in the ring-shaped area inwardly of the peripheral end of the diaphragm, wherein the springs are interconnected to the peripheral end of the diaphragm, so that the diaphragm is bridged across the internal area of the wall via the springs.

Without application of a bias voltage, the peripheral end of the diaphragm does not come in contact with the opening edge of the stopper plate. Hence, it is possible to establish a balance between the acoustic space and the non-acoustic space (positioned close to the wiring portion) in air pressure by means of the passage defined by the diaphragm, stopper plate, and wall. Upon application of a bias voltage, the internal portion of the diaphragm, which is defined inwardly of the contact positions with the spacers, approaches the plate; the external portion (or peripheral portion) of the diaphragm, which is defined externally of the contact positions with the spacers, approaches the stopper plate due to the rigidity of the diaphragm; and the peripheral end of the diaphragm partially comes in contact with the opening edge of the stopper plate. This reduces the width of the passage connecting between the acoustic space and the non-acoustic space, wherein the diaphragm vibrates due to sound waves. Therefore, the aforementioned modification can offer similar effects as the first embodiment.

In the first embodiment, the spacers are connected to the plate. It is possible to modify the first embodiment such that the spacers are not connected to the plate but are connected to the diaphragm. In this modification, upon application of a bias voltage, the diaphragm approaches the plate, so that the opposite ends opposite to the interconnection portions of the spacers interconnected to the diaphragm come in contact with the plate. Herein, due to the rigidity of the diaphragm, the external portion of the diaphragm, which is external of the interconnection portions with the spacers, approaches the stopper plate, and the peripheral end of the diaphragm partially comes in contact with the opening edge of the stopper plate. Incidentally, the spacers can be further modified such that they are isolated from both the plate and the diaphragm and are connected to the wall, for example.

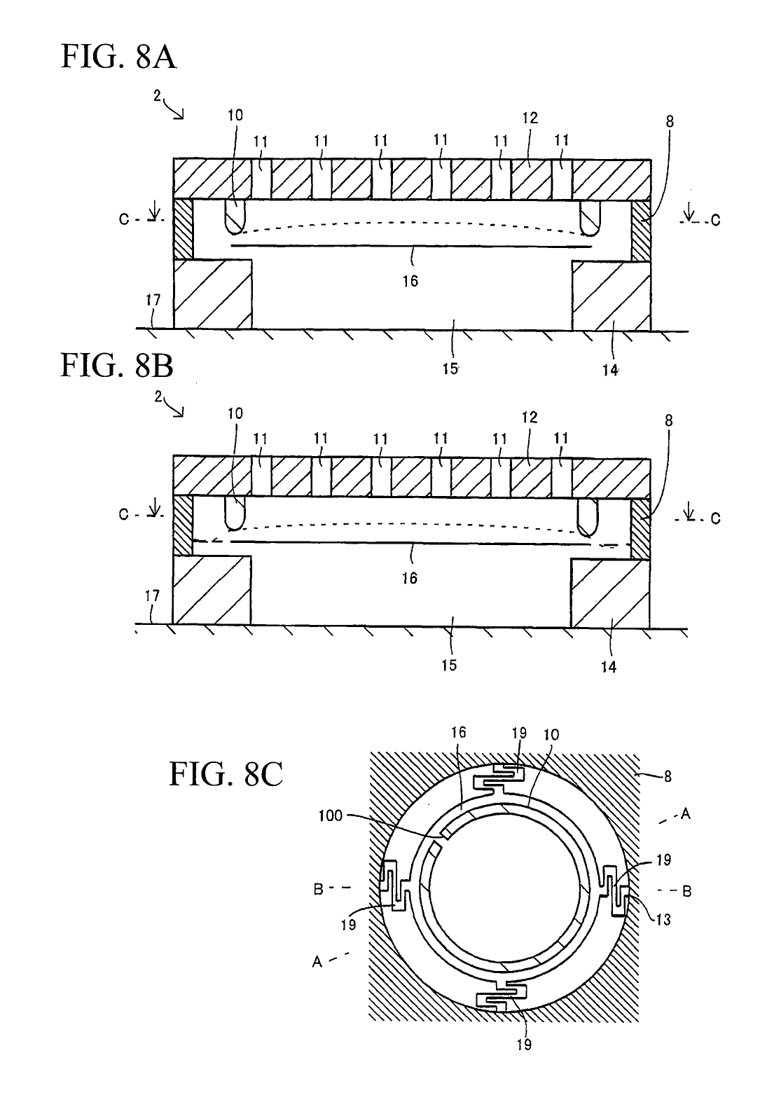

Next, a condenser microphone 2 according to a variation of the first embodiment will be described in detail. FIGS. 8A, 8B, and 8C are sectional views diagrammatically showing the constitution of the condenser microphone 2 without specific illustrations regarding the laminated structure of films, wherein the parts identical to those shown in FIGS. 1A, 1B, and 1C are designated by the same reference numerals; hence, duplicate description thereof is omitted.

The cutting planes of FIGS. 8A and 8B are perpendicular to the surface of the plate 12, and the cutting plate of FIG. 8C is parallel with the surface of the plate 12. FIG. 8C shows the diaphragm 16 viewed from the plate 12. Specifically, FIG. 8A is a sectional view taken along line A-A in FIG. 8C, and FIG. 8B is a sectional view taken along line B-B in FIG. 8C.

In the claim language, the wall can be defined as the aggregation of the wall 8, the substrate 14, and the external portion of the plate 12 external of the spacer 10, so that it encompasses the non-acoustic space together with the diaphragm 16, the spacer 10, and the wiring portion 17. This variation shown in FIGS. 8A to 8C differs from the first embodiment shown in FIGS. 1A to 1C in that the spacer 10 is integrally formed substantially in a ring shape at a position external of the outmost sound hole 11.

The width of the spacer 10 measured in its radial direction is 4 μm, for example. A slit 100 serving as a gap is formed in the ring-shaped spacer 10. The slit 100 is shaped with a width of 4 μm and a height of 4 μm. The cutoff frequency depends on the shape of the slit 100, wherein the slit 100 having the aforementioned dimensions realizes the cutoff frequency of approximately 30 Hz that is close to the lower-limit of the audio frequency range.

Next, the overall operation of the condenser microphone 2 will be described. Upon application of a bias voltage, the diaphragm 16 moves close to the plate 12, wherein the ring-shaped peripheral portion of the diaphragm 16 comes in contact with the spacer 10. FIGS. 8A and 8B show using dotted lines that the diaphragm 16 partially comes in contact with the spacer 10. Sound waves are transmitted through the sound holes 11 of the plate 12 so as to reach the diaphragm 16, which thus vibrates due to sound waves. When the diaphragm 16 partially comes in contact with the spacer 10, the non-acoustic space defined by the diaphragm 16 in proximity to the wiring portion 17 is substantially isolated from the acoustic space except for the prescribed space corresponding to the spacer 10. Since it is difficult for sound waves, which are detected subjects, to enter into the non-acoustic space defined by the diaphragm 16, it is possible to prevent the sensitivity of the condenser microphone 2 from being unexpectedly degraded. Without application of a bias voltage, the diaphragm 16 does not come in contact with the spacer 10, so that no air pressure difference is established between the acoustic space and the non-acoustic space partitioned by the diaphragm 16. Even when the bias voltage is applied to the condenser microphone 2, it is possible to establish a balance between the air pressure of the non-acoustic space and the atmospheric pressure by means of the slit 100 of the spacer 10. This prevents the diaphragm 16 from being unexpectedly destroyed due to the air pressure difference. In addition, it is possible to prevent the sensitivity of the condenser microphone 2 from being degraded due to the air pressure difference.

The number of the slits 100 can be appropriately determined as long as the cutoff frequency remains out of the audio frequency range. That is, it is possible to form a plurality of slits 100 in the spacer 10. In this case, it is preferable that an additional gap be formed at a prescribed position (regarding the diaphragm 16, for example) other than the spacer 10 in order to establish a balance between the air pressure of the non-acoustic space and the atmospheric pressure.

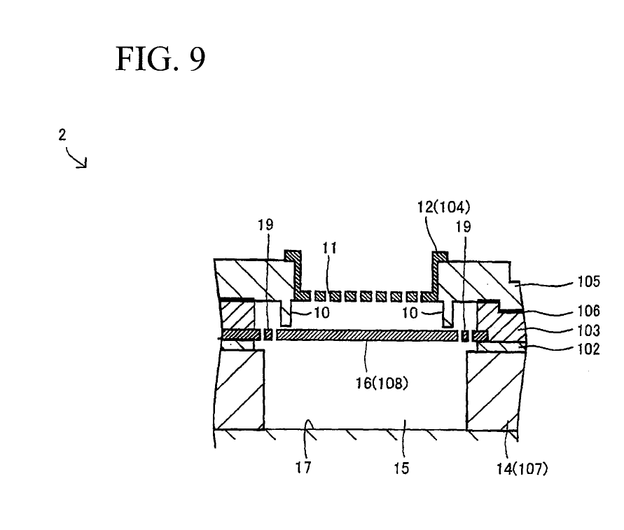

FIG. 9 is a sectional view showing an example of a laminated structure of films forming the condenser microphone 2.

The substrate 14 is formed using the wafer 107 composed of monocrystal silicon.

The wall 8 is constituted of the etching stopper film 102, the spacer film 103 used for the formation of a gap between the diaphragm 16 and the plate 12, and the insulating film 105 forming the spacer 10, etc.

The plate 12 is formed using the conductive film 104 so as to form the fixed electrode. The conductive film 104 joins the insulating film 105 used for the formation of the wall 8.

The spacer 10 is formed using the insulating film 105.

The diaphragm 16 and the springs 19 are formed using the conductive film 108 that is also used for the formation of the vibrating electrode. The conductive film 108 joins between the etching stopper film 102 and the spacer film 103.

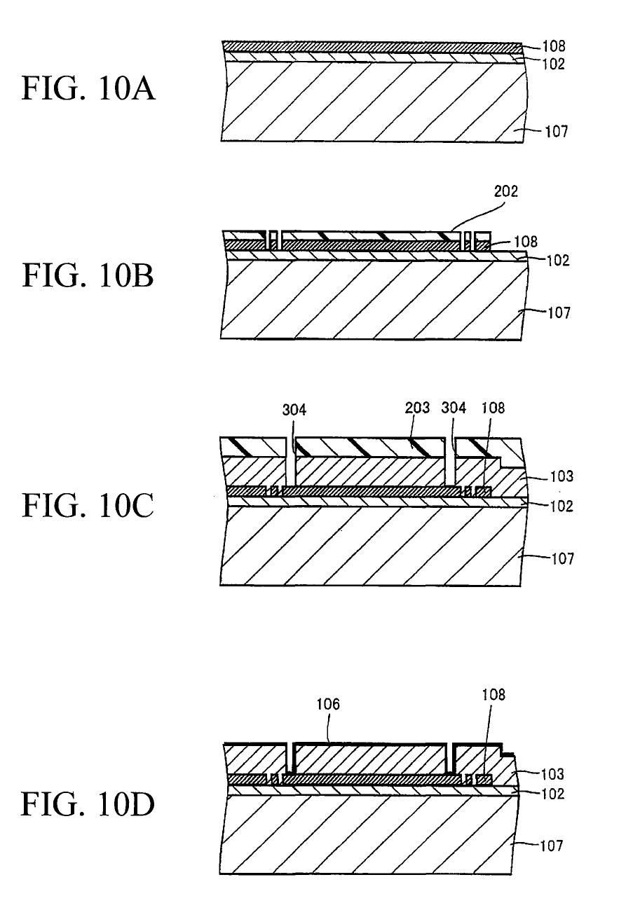

Next, a manufacturing method of the condenser microphone 2 will be described in detail with reference to FIGS. 10A to 10D, FIGS. 11A to 11D, and FIGS. 12A and 12B, each of which is a sectional view showing a one-chip region, wherein pads used for connecting a signal processing circuit (not shown) to the fixed electrode and the vibrating electrode can be appropriately designed and are not illustrated.

In a first step shown in FIG. 10A, the etching stopper film 102 is formed on the wafer 107 composed of monocrystal silicon. The etching stopper film 102 is a sacrifice film having an insulating property composed of SiO₂, which is used to perform endpoint control in Deep-RIE. Next, the conductive film 108 is formed on the etching stopper film 102. For example, the conductive film 108 is composed of a metal film or a polycrystal silicon film, which is subjected to decompression CVD, which is doped with impurities such as phosphorus (P), and which is subjected to annealing.

In a second step shown in FIG. 10B, the pattern of the resist mask 202 is transferred to the conductive film 108, thus forming the outline of the diaphragm 16 and the outlines of the springs 19, which are formed using the conductive film 108.

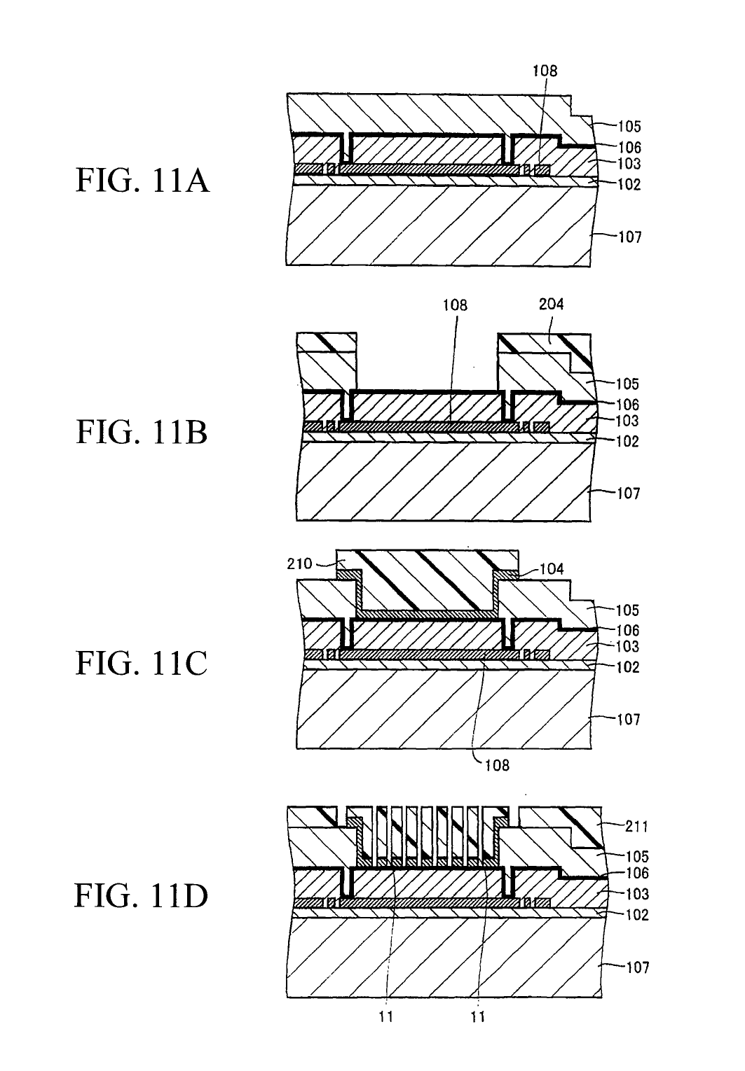

In a third step shown in FIG. 10C, the spacer film 103 is formed above the etching stopper film 102 and the conductive film 108. The pattern of the resist mask 203 is transferred to the spacer film 103, thus forming the hole 304 in the spacer film 103. The hole 304 is used for the formation of the spacer 10 and is formed substantially in a ring shape, a prescribed part of which is cut out to form the slit 100. The spacer 103 is formed with a desired thickness by repeatedly performing CVD realizing thin deposition of SiO₂ and annealing. The hole 304 runs through the spacer film 103 to reach the conductive film 108, which is thus partially exposed, by way of etching. Incidentally, etching can be stopped before the bottom of the hole 304 reaches the conductive film 108, which is thus not exposed. This can eliminate the after-treatment step shown in FIG. 11A.

The hole 304 is not necessarily formed by way of the resist patterning and etching; that is, it can be formed by use of the nano-imprint technology, for example.

In a fourth step shown in FIG. 10D, the insulating film 106 is formed on the spacer film 103. The insulating film 106 is removed in the following step, thus making the spacer 10 and the diaphragm 16 be isolated from each other. The insulating film 106 is composed of SiO₂, which is subjected to CVD, for example.

In a fifth step shown in FIG. 11A, the insulating film 105 is formed on the insulating film 106. The insulating film 105 is composed of a prescribed material having etching selectiveness with the spacer film 103 and the insulating film 106. The insulating film 105 is formed in a desired thickness by repeatedly performing decompression CVD and annealing, for example.

In a sixth step shown in FIG. 11B, the pattern of the resist mask 204 is transferred to the insulating film 105, thus removing unwanted portions of the insulating film 105.

In a seventh step shown in FIG. 11C, the insulating film 105 is partially removed, then, the conductive film 104 is formed to partially cover the upper surface of the insulating film 105 and to cover the exposed area of the insulating film 106. The pattern of a resist mask 210 is transferred to the conductive film 104, thus forming the circumferential outline of the plate 12 (which is formed using the conductive film 104). The conductive film 104 is composed of a metal film or the polycrystal silicon film, which is subjected to decompression CVD, which is doped with impurities such as phosphorus (P), and which is subjected to annealing.

In an eighth step shown in FIG. 11D, the pattern of the resist mask 211 is transferred to the conductive film 104 and the insulating film 105, thus forming the sound holes 11 of the plate 12 (which is formed using the conductive film 104). Specifically, the sound holes 11 are formed by way of anisotropic dry etching.

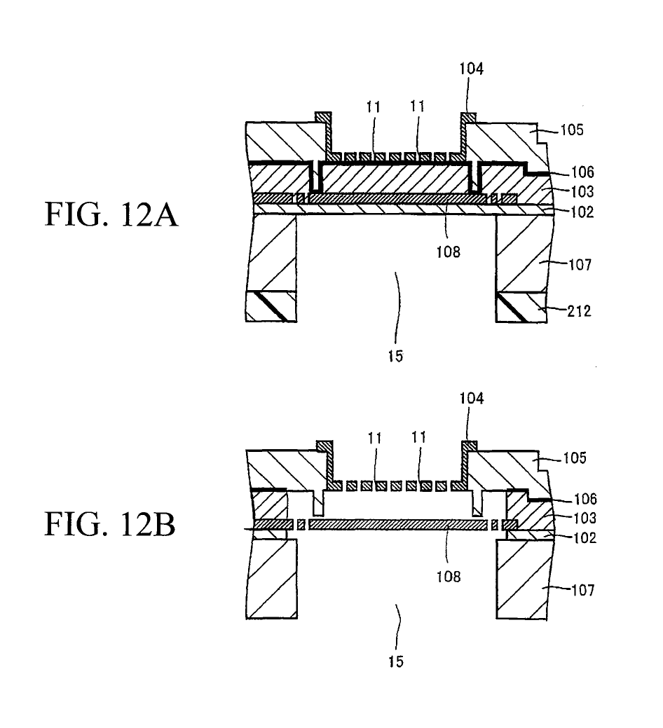

In a ninth step shown in FIG. 12A, a resist mask 212 is formed on the backside of the wafer 107, then, the waver 107 is subjected to Deep-RIE so as to form the cavity 15.

In a tenth step shown in FIG. 12B, the insulating film 105 is used as the etching stopper so as to supply an etchant to the sound holes 11 and the cavity 15, thus removing unwanted portions in the etching stopper film 102, the spacer film 103, and the insulating film 106 by way of wet etching.

Lastly, the wafer 107 is divided into individual pieces. Thus, it is possible to complete the production of the condenser microphone 2 shown in FIG. 9.

It is possible to further modify the condenser microphone 2 in a variety of ways. That is, the condenser microphone 2 is not necessarily designed such that the diaphragm 16 is positioned between the substrate 14 and the plate 12. Instead, it is possible to redesign the condenser microphone 2 in such a way that the plate 12 is positioned between the substrate 14 and the diaphragm 16.

In addition, the spacer 10 is not necessarily connected to the plate 12; that is, the spacer 10 can be connected to the diaphragm 16 instead of the plate 10. Furthermore, the spacer 10 can be isolated from both the plate 12 and the diaphragm 16, wherein it can be connected to the wall 8.

Lastly, the first embodiment and its variation can be further modified within the scope of the invention defined by the appended claims. In particular, the film composition, the film formation method, the film outline formation method, and the manufacturing procedures adapted to the aforementioned manufacturing methods can be appropriately determined dependent upon the combination of film materials, the film thickness, and the required outline formation precision, which are factors realizing the desired physical properties adapted to the condenser microphones; hence, they are not restrictions.

### 2. Second Embodiment

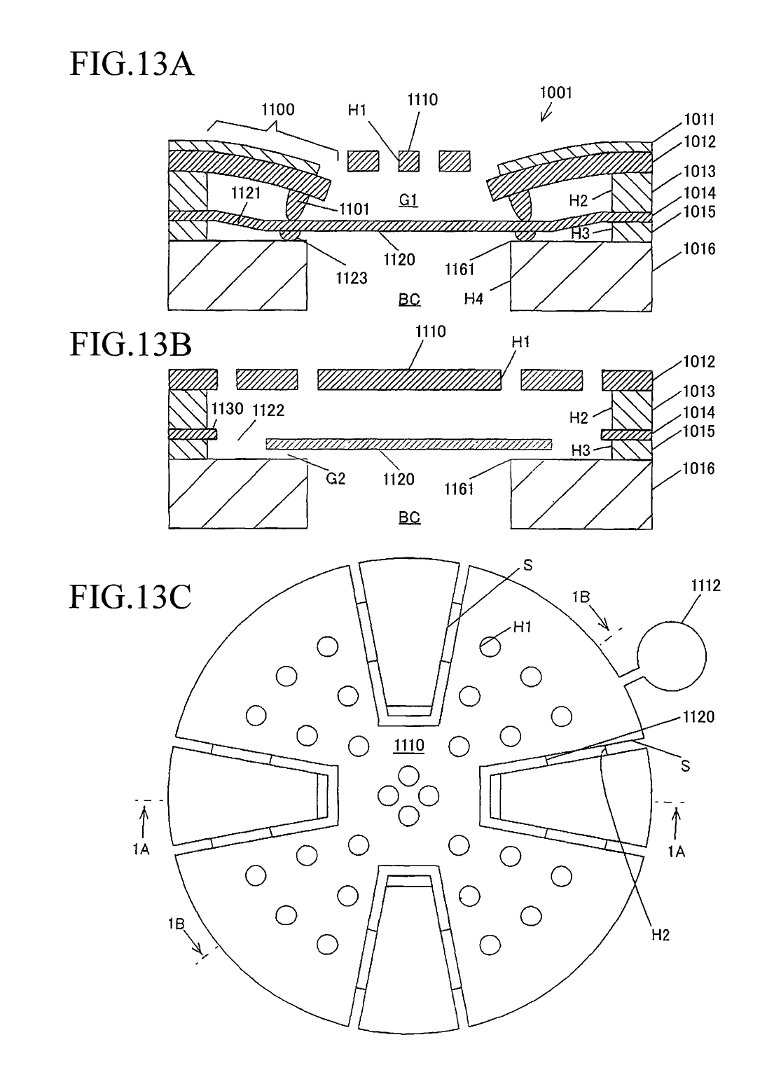

Next, a condenser microphone 1001 will be described in detail in accordance with a second embodiment of the present invention. FIGS. 13A and 13B are sectional views diagrammatically showing the essential parts of the condenser microphone 1001. The condenser microphone 1001 is a chip in which plural thin films are deposited on a substrate (or a stopper plate) 1016 composed of silicon and which is encapsulated in a package constituted of a wiring substrate and a cover (both not shown).

A through-hole H4 is formed to run through the substrate 1016. An opening 1161 of the through hole H4 forms an opening of a back cavity BC that is closed by the wiring substrate (not shown).

A first spacer film 1015 is deposited on the surface of the substrate 1016 and is formed using an insulating film composed of SiO₂, for example. A circular through-hole H3 is formed to run through the first spacer film 1015.

A diaphragm electrode film 1014 is deposited on the surface of the first spacer film 1015 and is formed using a conductive film, which is doped with impurities such as phosphorus (P) and which is composed of polycrystal silicon, for example.

A second spacer film 1013 is deposited on the surface of the diaphragm electrode film 1014 and is formed using an insulating film composed of SiO₂, for example. A circular through-hole H2 is formed to run through the second spacer film 1013.

A plate electrode film 1012 is deposited on the surface of the second spacer film 1013 and is formed using a conductive film, which is doped with impurities such as phosphorus (P) and which is composed of polycrystal silicon, for example. An internal stress exerted in a tensile direction (hereinafter, simply referred to as a tensile stress) still remains in the plate electrode film 1012.

A compressive film 1011 is deposited on the surface of the plate electrode film 1012 and is formed using an insulating film composed of SiO₂, for example. An internal stress exerted in a compressive direction (hereinafter, simply referred to as a compressive stress) still remains in the compressive film 1011.

FIG. 13C is a plan view showing the essential parts of the condenser microphone 1001.

A plate 1110 is composed of the plate electrode film 1012 whose peripheral portion joins the second spacer film 1013, wherein the plate electrode film 1012 is bridged across the second spacer film 1013 so as to close the through-hole H2. A plurality of through-holes H1 (serving as a first through-hole) are formed in the plate 1110. The outline of the plate 1110 depends upon the outline of the through-hole H2, wherein no specific restriction is applied to the shape of the plate 1110 as long as the plate 1110 has a relatively large area positioned opposite to a diaphragm 1120, and the plate 1110 has sufficient rigidity against deflection thereof. A pad 1112 is connected to the plate 1110 in order to establish wiring therefor.

A first gap G1 lying between the plate 1110 and the diaphragm 1120 is realized by the formation of the through-hole H2 in the second spacer film 1013. The first gap G1 increases in response to deflection of cantilevers 1100, while it is fixedly set to a constant distance when the diaphragm 1120 comes in contact with the substrate 1016. The first gap G1 communicates with an atmospheric space via the through-hole H1 and slits S.

As shown in FIG. 13A, the cantilevers 1100 are each constituted of the plate electrode film 1012 and the compressive film 1011 and are each isolated from the plate 1110 via the slits S formed in the plate electrode film 1012. The base portions of the cantilevers 1100 join the second spacer film 1013, so that the cantilevers 1100 project inwardly toward the center of the through-hole H2 of the second spacer film 1013. The tensile stress remains in the plate electrode film 1012 positioned close to the diaphragm electrode film 1014, while the compressive stress remains in the compressive film 1011 positioned far from the diaphragm electrode film 1014. Therefore, the cantilevers 1100 depress the diaphragm 1120 toward the substrate 1016 in such a way that the distal ends of the cantilevers 1100 whose base portions are fixed in position are deflected downwardly toward the diaphragm 1120.

Projections 1101 are formed in the distal ends of the cantilevers 1100, which project toward the diaphragm 1120, and are brought into contact with the diaphragm 1120. The heights of the projections 1101 are smaller than the thickness of the second spacer film 1013 intervened between the diaphragm electrode film 1014 and the plate electrode film 1012. Due to the deflection of the cantilevers 1100 (dependent upon their internal stresses), the distal ends of the projections 1101 depress the diaphragm 1120 downwardly toward the substrate 1016 in contact with the diaphragm 1120. The projections 1101 can be formed using the diaphragm electrode film 1014. Alternatively, they can be formed using another deposited film joining the diaphragm electrode film 1014. In addition, the projections 1101 each have either an insulating property or a conductive property.

In order to deflect the cantilevers 1100 toward the diaphragm 1120, it is preferable that the internal stress of the cantilever 1100 varies in the thickness direction, i.e., the compressive stress of the cantilever 1100 becomes small in the direction toward the diaphragm 1120. The condenser microphone 1001 of the second embodiment is designed such that each of the cantilevers 1100 has a two-layered structure constituted of two films, wherein in order to vary the internal stress in the thickness direction, it is preferable that the compressive stress be intentionally applied to the film positioned far from the diaphragm 1120, and the tensile stress be intentionally applied to the film positioned close to the diaphragm 1120. Even when the cantilever 1100 has a single-layered structure constituted of a single film, it is possible to control the internal stress of the cantilever 1100 such that the internal stress of the compressive direction increases in the surface by appropriately changing formation conditions of the film during its deposition. The internal stress of the compressive direction may increase in the surface without changing formation conditions of the film during its deposition. That is, the internal stress of the compressive direction increases in the surface of the film, which is formed by way of deposition of polysilicon doped with phosphorus in situ, by increasing the dopant, by performing ion implantation of phosphorus on the surface after the deposition of polycrystal silicon, or by performing lamp annealing on the surface after the deposition of polycrystal silicon. It is possible to make the cantilever 1100 be deflected toward the diaphragm 1120 due to the internal stress of the tensile direction only. In this case, it is necessary to form a deposited film forming the cantilever 1100 in such a way that the tensile stress is increased in the thickness direction toward the diaphragm 1120.

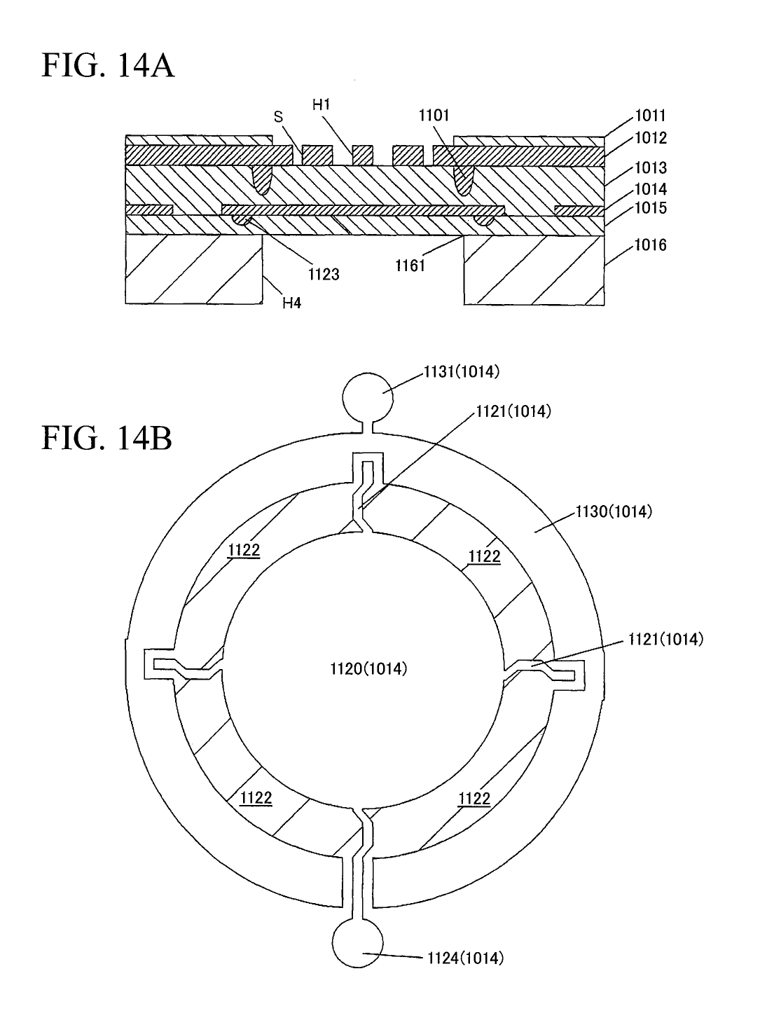

FIG. 14B is a plan view showing a pattern of the diaphragm electrode film 1014. The diaphragm electrode film 1014 includes the diaphragm 1120, a plurality of interconnection portions 1121 for making the diaphragm 1120 be bridged across the first spacer film 1015, a guard electrode 1130, and pads 1131 and 1124. The diaphragm electrode film 1014 is formed using a conductive film, which is composed of SiO₂ and which is doped with impurities such as phosphorus (P), for example. The outline of the diaphragm 1120 embraces an opening 1161 of the back cavity BC formed in the substrate 1016. That is, the opening 1161 of the back cavity BC is covered with the diaphragm 1120.

The diaphragm 1120 is isolated from the guard electrode 1130, wherein a part of a gap, by which the diaphragm 1120 is isolated from the guard electrode 1130, forms an air hole (referred to as a second air hole) 1122. The air hole 1122 is illustrated with hatchings in FIG. 14B. Since the air hole 1122 is formed outside of the opening 1161 of the back cavity BC, a second gap G2 is formed between the peripheral end of the diaphragm 1120 and the opening edge of the substrate 1016 (see FIG. 13). The second gap G2 communicates with the back cavity BC and the air hole 1122. That is, the back cavity BC communicates with the atmospheric apace via the second gap G2, the air hole 1122, the first gap G1, and the through-hole H1. Among the second gap G2, the air hole 1122, the first gap G1, and the through-hole H1, the second gap G2 has the highest acoustic resistance. It is possible to increase the acoustic resistance of the second gap G2 by reducing the second gap G2 (or by reducing the heights of projections 1123 of the interconnection portions 1121 or by enlarging the overlapped area between the peripheral end of the diaphragm 1120 and the opening edge of the substrate 1016 in plan view, thus improving the sensitivity particularly in low-frequency ranges.

As shown in FIGS. 13A and 13B, the interconnection portions 1121 are elongated externally from the outer circumference of the diaphragm 1120 having a circular shape. The diaphragm 1120 is connected to the pad 1124 via the interconnection portion 1121. Since the distal ends of the interconnection portions 1121 join the first spacer film 1015, the diaphragm 1120 is bridged across the through-hole H3. The outlines of the interconnection portions 1121 have bent band-like shapes; hence, the interconnection portions 1121 are reduced in modulus of elasticity in a radial direction of the diaphragm 1120. Therefore, the internal stress applied to the center portion of the diaphragm electrode film 1014 corresponding to the diaphragm 1120 is released by means of the interconnection portions 1121. This increases the displacement of the diaphragm 1120 against pressure; hence, it is possible to increase the sensitivity in all frequency ranges.

As shown in FIG. 13A, the diaphragm 1120 has the projections 1123, which project downwardly toward the substrate 1016. The projections 1123 can be formed using the diaphragm electrode film 1014 or another deposited film joining the diaphragm electrode film 1014. The distal ends of the projections 1123 of the diaphragm 1120 are brought into contact with the surface of the substrate 1016. Due to the provision of the projections 1123, the second gap G2 is constantly maintained with the same dimensions between the diaphragm 1120 and the substrate 1016. Incidentally, the projections 1123 of the diaphragm 1120 may overlap with the projections 1101 of the cantilevers 1100 in plan view, or they do not overlap with each other in plan view.

Next, a manufacturing method of the condenser microphone 1001 will be described in detail. The condenser microphone 1001 is manufactured by way of semiconductor device processing technology. Specifically, a plurality of thin films are sequentially deposited on the substrate 1016 (composed of a bulk material); and gaps are appropriately formed by way of etching or liftoff techniques; thus, it is possible to form the structure shown in FIGS. 13A to 13C.

FIG. 14A is a longitudinal sectional view diagrammatically showing an intermediate structure of the condenser microphone 1001 during the manufacturing process. Herein, the first spacer film 1015, the diaphragm 1014, the second spacer film 1013, the plate electrode film 1012, and the compressive film 1011 are sequentially formed on the substrate 1016, wherein the diaphragm electrode film 1014, the plate electrode film 1012, and the compressive film 1011 are subjected to patterning. The through-hole H4 is formed in the substrate 1016 by way of Deep-RIE. After the compressive film 1011 is protected using a photoresist, the first spacer film 1015 and the second spacer film 1013 are selectively removed by way of anisotropic etching, thus forming the condenser microphone 1001 shown in FIGS. 13A to 13C. The shape of the through-hole H3 of the first spacer film 1015 and the shape of the through-hole H2 of the second spacer film 1013 depend upon the shape of the opening 1161 of the substrate 1016, the shape of the through-hole H1 of the plate electrode film 1012, and the shapes of the slits S.

The projections 1123 can be formed in such a way that recesses are formed in the first spacer film 1015 (which is formed directly thereunder) and are then embedded with the diaphragm electrode film 1014. Alternatively, the recesses are embedded with another deposited film having an insulating property or a conductive property other than the diaphragm electrode film 1014; the prescribed portion of the deposited film, which sticks out of the recesses is removed by way of the planation process; and then, the diaphragm electrode film 1014 is subjected to deposition. Similarly, the projections 1101 can be formed using recesses, which are formed in the second spacer film 1013 (which is formed directly thereunder).

In FIG. 14A, different internal stresses are applied in thickness directions on the prescribed portion of the plate electrode film 1012 and the prescribed portion of the compressive film 1011, which are used for the formation of the cantilevers 1100. That is, an intense compressive stress occurs in the compressive film 1011 rather than the plate electrode film 1012 positioned close to the diaphragm electrode film 1014. For this reason, due to the formation of the through-hole H3 of the first spacer film 1015 and the through-hole H2 of the second spacer film 1013, the distal end of the cantilever 1100 is deflected toward the diaphragm 1120 so that the projection 1101 (which comes in contact with the diaphragm 1120) depresses the diaphragm 1120 toward the substrate 1016. This increases the first gap G1 between the diaphragm 1120 and the plate 1110 while decreasing the second gap G2 between the diaphragm 1120 and the substrate 1016. At this time, the interconnection portions 1121 having bent band-like shape, which are formed in the diaphragm electrode film 1014, are expanded in a radial direction of the diaphragm 1120; hence, the internal stress of the diaphragm 1120 does not increase but decreases in the tension direction. When the distal ends of the projections 1123 of the diaphragm 1120 come in contact with the substrate 1016, the cantilevers 1100 and the interconnection portions 1121 are stabilized in shapes as shown in FIGS. 13A and 13B.

Within the space existing between the atmospheric space and the back cavity BC, the second gap G2 realizing the maximum acoustic resistance depends upon the heights of the projections 1123 of the diaphragm 1120. The horizontal width of the second gap G2 (lying in the radial direction of the diaphragm 1120) depends upon the width of the sticking portion of the diaphragm 1120 that horizontally sticks out of the opening 1161 of the back cavity BC. The sensitivity of the condenser microphone 1001 in low-frequency ranges depends upon the second gap G2 and the volume of the back cavity BC.

In the present embodiment, the second gap G2, which determines the sensitivity of the condenser microphone 1001 in low-frequency ranges, is smaller than the distance between the diaphragm 1120 and the substrate 1016 just after the diaphragm electrode film 1014 is deposited on the first spacer film 1015. In addition, the first gap G1 (between the diaphragm 1120 and the plate 1110), which is related to the rated pressure and the stability against mechanical vibration in the condenser microphone 1001, becomes larger than the thickness of the second spacer film 1013 due to the deformation of the cantilevers 1100. In other words, the present embodiment uses the internal stresses of the deposited films for the purpose of the setup of the aforementioned gaps; hence, it is possible to appropriately increase the first gap G1 while decreasing the second gap G2. That is, the present embodiment is capable of improving the sensitivity in low-frequency ranges, increasing the rated pressure, and improving the stability against mechanical vibration. As a result, it is possible to establish a high-level balance between the sensitivity and the stability in the condenser microphone 1001.

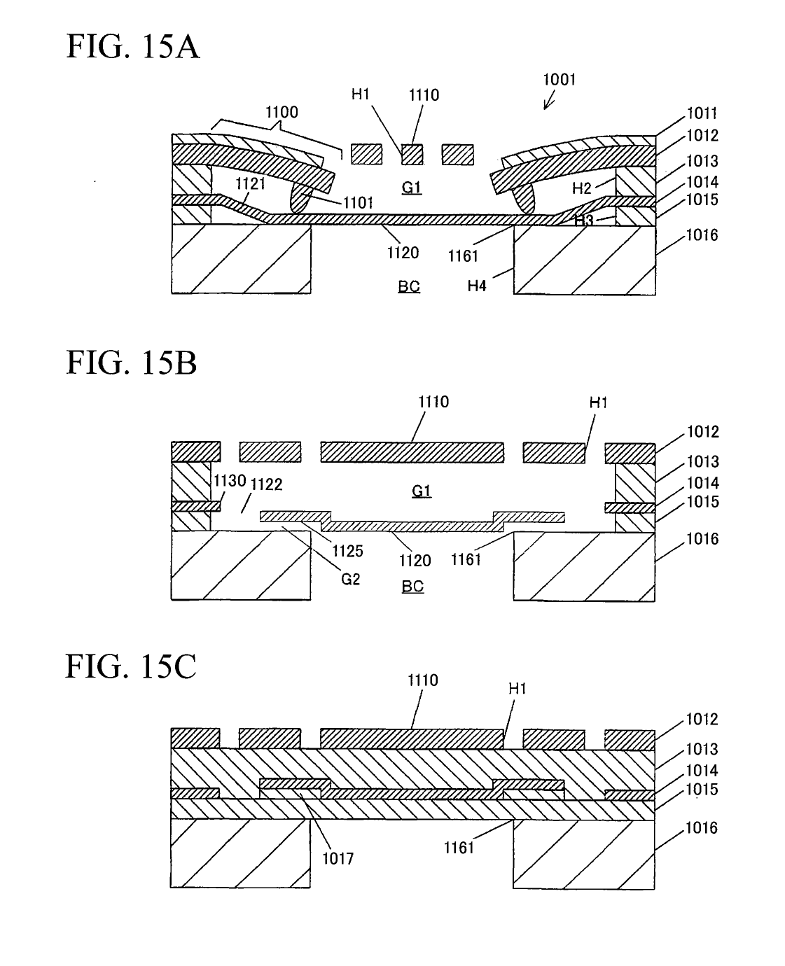

The condenser microphone 1001 of the second embodiment can be further modified in a variety of ways; therefore, variations of the second embodiment will be described with reference to FIGS. 15A-15C, 16, 17, 18A-18C, 19, and 20A-20B, wherein parts identical to those shown in FIGS. 13A-13C and FIGS. 14A-14B are designated by the same reference numerals; hence, duplicate description thereof will be omitted.

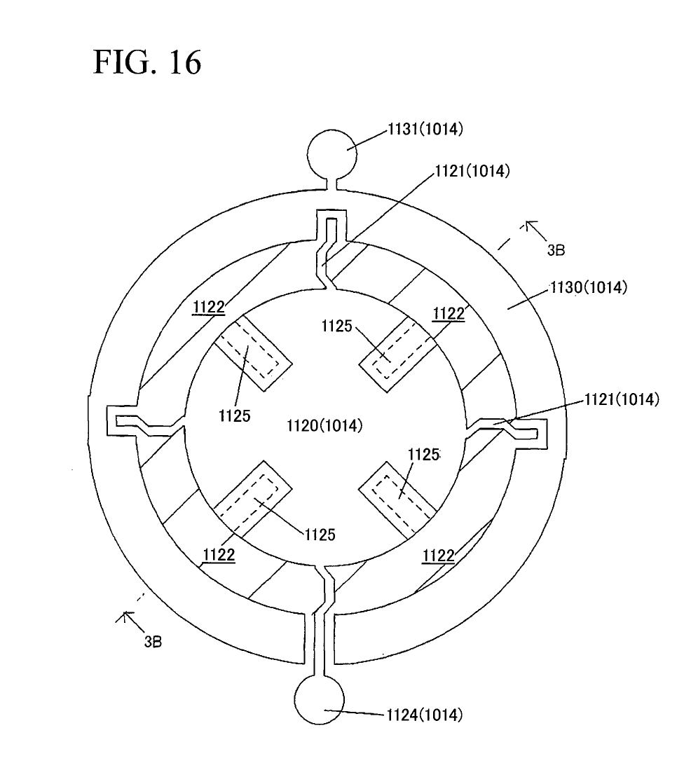

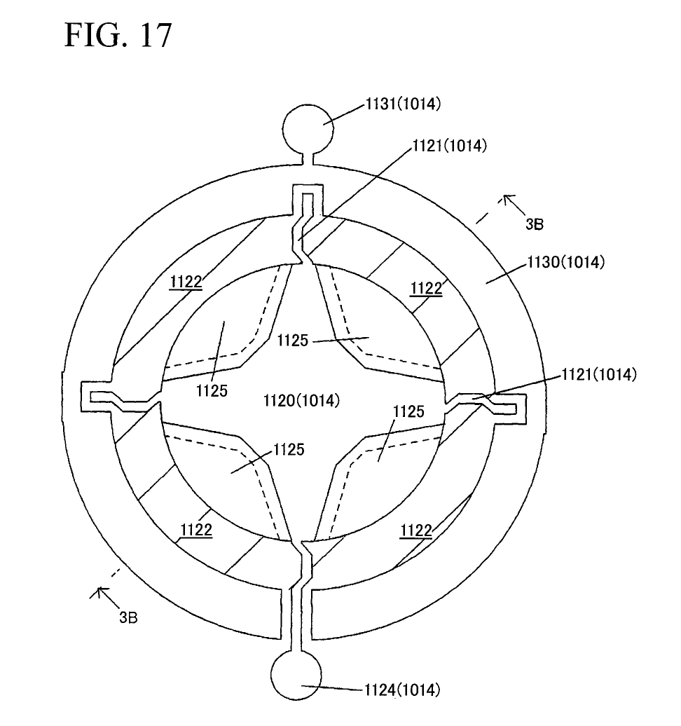

FIGS. 15A and 15B are sectional views showing a variation of the second embodiment with regard to the formation of the second gap G2; and FIGS. 16 and 17 are plan views showing variations of the diaphragm electrode film 1014 realizing the formation of the second gap G2 shown in FIGS. 15A and 15B. FIGS. 15A and 15B show cutting planes, which are illustrated in relation to FIGS. 13A and 13B taken along lines 1A-1A and 1B-1B in FIG. 13C. As shown in FIGS. 15A-15B, 16, and 17, the second gap G2 can be formed using channels 1125 that are elongated inwardly from the peripheral portion of the diaphragm 1120 in its radial direction. The widths of the channels 1125 can be reduced as shown in FIG. 16, or they can be enlarged as shown in FIG. 17. That is, the channels 1125 can be appropriately designed in shapes and dimensions so as to realize a desired acoustic resistance. First ends of the channels 1125 communicate with the air hole 1122, while second ends thereof communicate with the opening 1161 of the back cavity BC. The second gap G2 depends upon the depths of the channels 1125. Before the deposition of the diaphragm electrode film 1014 as shown in FIG. 15C, a sacrifice film 1017 is formed on the substrate 1016 in correspondence with the channels 1125, thus realizing the formation of the channels 1125. It is preferable that the sacrifice film 1017 be composed of a prescribed material that can be simultaneously etched together with the first spacer film 1015 and the second spacer film 1013.

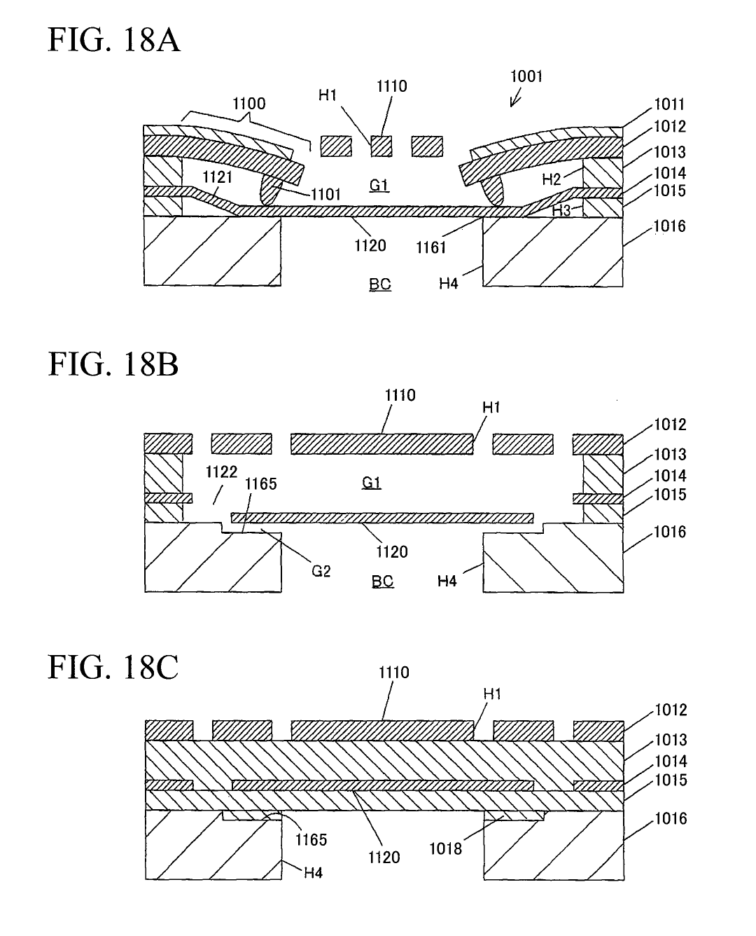

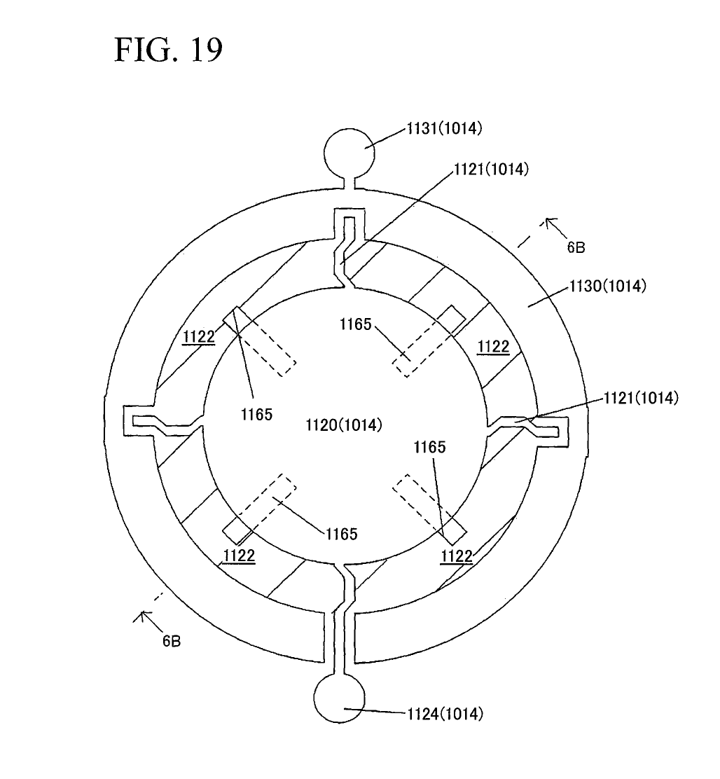

FIGS. 18A and 18B are sectional views showing another variation of the second embodiment with regard to the formation of the second gap G2. FIG. 19 is a plan view showing the diaphragm electrode film 1014 realizing the formation of the second gap G2 shown in FIGS. 18A and 18B. FIGS. 18A and 18B show cutting planes, which are illustrated in relation to FIGS. 13A and 13B taken along lines 1A-1A and 1B-1B in FIG. 13C. As shown in FIGS. 18A-18B and FIG. 19, the second gap G2 can be formed using channels 1165, which are elongated externally from the opening 1161 at the opening edge of the substrate 1016. First ends of the channels 1165 communicate with the air hole 1122, and second ends thereof communicate with the opening 1161 of the back cavity BC. The second gap G2 depends upon the depths of the channels 1165. As shown in FIG. 18C, before the deposition of the first spacer film 1015, the channels 1165 are formed in the substrate 1016 and are embedded with a sacrifice film 1018. It is preferable that the sacrifice film 1018 be composed of a prescribed material, which can be simultaneously etched with the first spacer film 1015 and the second spacer film 1013.

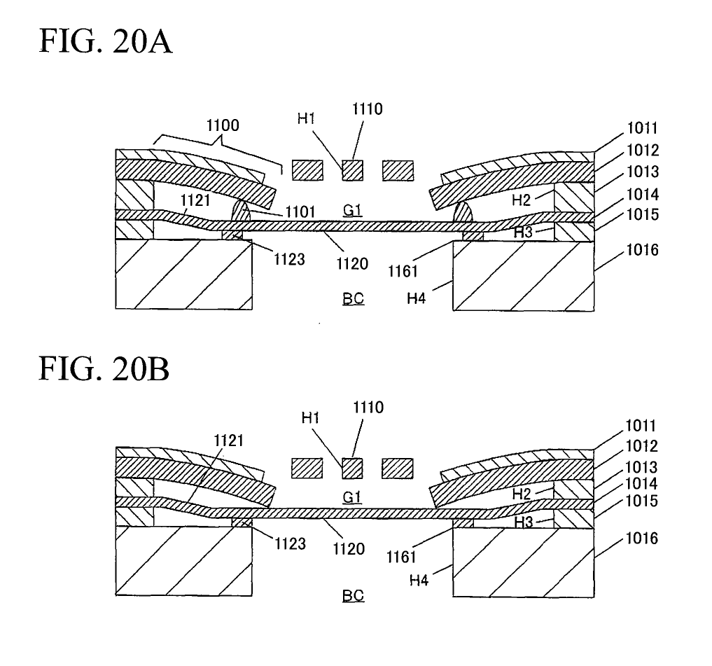

FIGS. 20A and 20B are sectional views showing a further variation of the second embodiment with regard to the formation of the first gap G1 and the second gap G2. FIGS. 20A and 20B show cutting planes, which are illustrated in relation to FIG. 13A taken along line 1A-1A in FIG. 13C. As shown in FIG. 20A, the projections 1101 are formed integrally with the diaphragm 1120, wherein the distal ends of the projections 1101 are brought into contact with the cantilevers 1100 so as to determine the dimensions of the first gap G1. In addition, the projections 1123 are integrally formed with the substrate 1016, wherein the distal ends of the projections 1123 are brought into contact with the diaphragm 1120 so as to determine the dimensions of the second gap G2 (see FIG. 13B). In other words, the projections 1123 can be formed using a deposited film whose backside joins the substrate 1016. Alternatively, as shown in FIG. 20B, projections are not necessarily formed with respect to the cantilevers 1100 and the diaphragm 1120.

Moreover, the plate 1110 and the diaphragm 1120 can be each formed in a single-layered structure having an insulating property partially or in a multilayered structure having a conductive property in the second and other layers. The plate 1110 and the diaphragm 1120 are each not necessarily formed in a circular shape and can be formed in a rectangular shape. The cantilevers 1100 can be formed using another layer other than the plate electrode film 1012, e.g., a deposited film formed between the plate electrode film 1012 and the diaphragm electrode film 1014, for example.

Lastly, the present invention is not necessarily limited to the first and second embodiments as well as their variations; hence, it is possible to realize other variations and modifications within the scope of the invention defined by the appended claims.

What is claimed is:

1. An electrostatic pressure transducer comprising:
a plate having a plurality of holes and forming a fixed electrode;
a diaphragm forming a vibrating electrode, which is positioned opposite to the fixed electrode;
at least one spacer that is positioned between the plate and the diaphragm in a ring-shaped area inwardly of a peripheral end of the diaphragm; and
a stopper plate having an opening, which is positioned opposite to the plate with respect to the diaphragm,
wherein the diaphragm vibrates relative to the plate in such a way that, due to electrostatic attraction occurring between the plate and the diaphragm, an internal portion of the diaphragm positioned inwardly of the spacer moves close to the plate while an external portion of the diaphragm positioned externally of the spacer moves opposite to the plate so that the peripheral end of the diaphragm partially comes in contact with an edge of the opening of the stopper plate.

2. An electrostatic pressure transducer comprising:
a plate having a plurality of holes and forming a fixed electrode;
a diaphragm forming a vibrating electrode, which is positioned opposite to the fixed electrode;
at least one spacer that is positioned between the plate and the diaphragm and that has a ring-shaped interior wall positioned externally of an outermost hole within the holes of the plate; and
a wall that supports a peripheral end of the plate so as to surround a non-acoustic space, which is defined by the diaphragm in proximity to a wiring portion, together with the diaphragm, the plate, and the wiring portion,
wherein the diaphragm vibrates relative to the plate in such a way that, due to electrostatic attraction occurring between the plate and the diaphragm, the diaphragm moves close to the plate so as to close an opening surrounded by the spacer and to substantially close the non-acoustic space in an airtight manner.

3. An electrostatic pressure transducer according to claim 1, which is a condenser microphone.

4. An electrostatic pressure transducer according to claim 2, which is a condenser microphone.

5. An electrostatic pressure transducer according to claim 1 further comprising:
a plurality of springs interconnected to the diaphragm; and
a support, which is interconnected to the springs so that the diaphragm is bridged across the support.

6. An electrostatic pressure transducer according to claim 2 further comprising:
a plurality of springs interconnected to the diaphragm; and
a support, which is interconnected to the springs so that the diaphragm is bridged across the support.

7. A manufacturing method adapted to the electrostatic pressure transducer according to claim 1, comprising the steps of:
forming a first film serving as the diaphragm;
forming a first insulating film on the first film;
forming a second film serving as the plate on the first insulating film;
forming at least one hole in the first insulating film by way of resist patterning and etching;
depositing a second insulating film whose composition differs from a composition of the first insulating film inside of the hole so as to form the spacer composed of the second insulating film; and
selectively removing the first insulating film from a prescribed area between the first film and the second film by way of wet etching.

8. A manufacturing method adapted to the electrostatic pressure transducer according to claim 2, comprising the steps of:
forming a first film serving as the diaphragm;
forming a first insulating film on the first film;
forming a channel substantially having a ring shape in the first insulating film by way of resist patterning and etching;
depositing a second insulating film whose composition differs from a composition of the first insulating film inside of the channel so as to form the spacer composed of the second insulating film;
removing an internal portion of the second insulating film positioned internally of the spacer;
removing the second insulating film so as to expose the first insulating film, on which the second film is formed; and
selectively removing the first insulating film from a prescribed area between the first film and the second film by way of wet etching.

9. An electrostatic pressure transducer according to claim 1 further comprising a plurality of cantilevers, each of which is deflected at a distal end thereof toward the diaphragm, which is thus depressed.

10. An electrostatic pressure transducer according to claim 9, wherein a first gap is formed between the diaphragm and the plate, the opening of the stopper plate forms a back cavity, a second gap having an acoustic resistance, which is exerted between the back cavity and a first through-hole of the plate, is formed between a peripheral end of the diaphragm and the stopper plate, and at least one second through-hole communicating with the first through-hole and the second gap is formed in the external portion of the diaphragm externally of the opening of the stopper plate, and the first gap communicates with the first through-hole.

11. An electrostatic pressure transducer according to claim 10, wherein the diaphragm has a plurality of projections whose distal ends come in contact with the stopper plate so as to form the second gap.

12. An electrostatic pressure transducer according to claim 10, wherein the stopper plate has a plurality of projections whose distal ends come in contact with the diaphragm so as to form the second gap.

13. An electrostatic pressure transducer according to claim 10, wherein the stopper plate has a plurality of channels, which are elongated externally from the back cavity, so as to form the second gap.

14. An electrostatic pressure transducer according to claim 10, wherein a plurality of second through-holes are formed in the external portion of the diaphragm.

15. An electrostatic pressure transducer according to claim 9, wherein each of the cantilevers is constituted of a plurality of films laminated together.

16. An electrostatic pressure transducer according to claim 15, wherein the cantilever and the plate are formed using a common film.

17. An electrostatic pressure transducer according to claim 9, wherein the spacer is attached to the distal end of the cantilever so as to project toward the diaphragm.

18. An electrostatic pressure transducer according to claim 9, wherein the spacer is attached to a surface of the diaphragm in proximity to the plate so as to project toward the cantilever.
